(19) United States
(12) Patent Application Publication
(10) Pub. No.: US 2022/0033305 A1
(43) Pub. Date: Feb. 3, 2022

(54) ENHANCING ASPHALT'S PROPERTIES WITH A BIO-BASED POLYMER MODIFIED LIQUID ASPHALT CEMENT

(71) Applicant: IOWA STATE UNIVERSITY RESEARCH FOUNDATION, INC., Ames, IA (US)

(72) Inventors: Eric W. COCHRAN, Ames, IA (US); Nacu HERNANDEZ, Ames, IA (US); Austin HOHMANN, Dubuque, IA (US); Ronald Christopher WILLIAMS, Ames, IA (US); Michael FORRESTER, Boone, IA (US); Baker KUEHL, Ankeny, IA (US); Conglin CHEN, Ames, IA (US)

(21) Appl. No.: 17/275,500

(22) PCT Filed: Sep. 17, 2019
(86) PCT No.: PCT/US19/51490

§ 371 Date: Mar. 11, 2021

Related U.S. Application Data
(60) Provisional application No. 62/732,238, filed on Sep. 17, 2018.

(51) Int. Cl. C04B 24/08; C04B 26/26; C04B 24/26; C04B 40/00; E01C 19/00; E01C 7/26

(52) U.S. Cl. CPC C04B 24/085; C04B 26/26; C04B 24/2641; C04B 2111/0075; C04B 40/0039; E01C 19/002; E01C 7/26; C04B 24/2676

(57) ABSTRACT

The present application is directed to a composition that includes a polymer comprising two or more units of monomer A, with monomer A being a radically polymerizable plant oil, animal oil, synthetic triglyceride, or mixture thereof and an epoxidized vegetable oil, an epoxidized fatty acid, or an epoxidized fatty ester. The present application is also directed to further compositions, methods of producing a liquid cement composition, and methods of paving.

This application claims the benefit of U.S. Provisional Patent Application Ser. No. 62/732,238, filed Sep. 17, 2018, which is hereby incorporated by reference in its entirety.

### FIELD

The present application relates to enhancing asphalt's properties with a bio-based polymer modified liquid asphalt cement.

### BACKGROUND

Asphalt binders produced at refineries are becoming stiffer due to an ever-increasing demand for more expensive lighter fraction products such as gasoline, diesel, jet fuel, etc. This has caused an increase in the need of materials that can soften, modify, repair, restore, or rejuvenate these asphalts. Polymer modification of asphalt is the process by which different types of polymers, mainly SBS type polymers, are incorporated into asphalt binder through mechanical mixing (shear blending) at a certain temperature over a specific time to react the asphalt binder with the polymer, causing the establishment of a rubbery elastic network (Lu et al., “On Polymer Modified Road Bitumens,” Thesis, Stockholm: KTH Royal Institute of Technology (1997)), thus improving the asphalt binder's performance at high temperatures, cracking resistance at low temperatures, and moisture resistance and fatigue life (Alataş et al., “Effects of Different Polymers on Mechanical Properties of Bituminous Binders and Hot Mixtures,” Constr. Build. Mater. 42:161-167 (2013); Gorkem et al., “Predicting Stripping and Moisture Induced Damage of Asphalt Concrete Prepared with Polymer Modified Bitumen and Hydrated Lime,” Constr. Build. Mater. 23(6):2227-2236 (2009); Isacsson et al, “Low-Temperature Cracking of Polymer-Modified Asphalt,” Mater. Struct. 31(1):58-63 (1998); Ponniah et al., “Polymer-Modified Asphalt Pavements in Ontario: Performance and Cost-Effectiveness,” Transp. Res. Rec. 1545:151-160 (1996); Tayfur et al., “Investigation of Rutting Performance of Asphalt Mixtures Containing Polymer Modifiers,” Constr. Build. Mater. 21(2):328-337 (2007); Von Quintus et al., “Quantification of Effect of Polymer-Modified Asphalt on Flexible Pavement Performance,” Transp. Res. Rec. 2001:141-154 (2007)). Chemical characteristics of both the polymer and the asphalt binder, the polymer content, and the process used to manufacture both the asphalt binder and the polymer play a big role in the final properties and the effectiveness of the polymer modified asphalt binder (Lu et al., “On Polymer Modified Road Bitumens,” Thesis, Stockholm: KTH Royal Institute of Technology (1997); Larsen et al., “Micro-Structural and Rheological Characteristics of SBS-Asphalt Blends During Their Manufacturing,” Constr. Build. Mater. 23(8):2769-2774 (2009)).

SBS type polymers have been the gold standard in polymer modification of asphalt. SBS type polymers are thermoplastic elastomers that can be thermally processed at high temperatures. These polymers are incorporated into asphalt through mixing and shearing at high temperatures to uniformly disperse the polymer. This addition is done at asphalt terminal facilities to create a polymer modified asphalt cement (PMAC). The process to make PMAC starts at the Asphalt Terminals where the SBS type polymers, in pellet form, are added to the asphalt through long periods of mixing and shearing at high temperatures and depending of the grade of the asphalt different modifiers can be added to reach the desired performance grade. The PMAC is then shipped to the contractors where is mixed with other modifiers, the aggregates, and sometimes with a percentage of Reclaimed Asphalt Pavement to produce the pavement mixtures, see FIG. 1. The whole process can be time and energy consuming.

During a pavement's construction and service life a binder's lower molecular weight components oxidize, volatize, and/or evaporate. This causes polymerization, of the higher molecular weight components, to occur whereby the binder becomes less viscoelastic in nature (more viscous at high temperature and less elastic at low temperature) (Gerardu et al, “Recycling of Road Pavement Materials in the Netherlands,” Road Engineering Division of Rijkswaterstaat, Delft (1985)). There have been several past studies on the use of rejuvenators with aged asphalt binder/recycled asphalt pavement (RAP) extracted and recovered binder. Often terms such as rejuvenator, recycling agent, softening agent, flux, and extender have been used interchangeably. Rejuvenation is achieved through the renewal of the volatiles and oils during which adhesion properties are kept. This makes it possible to return an aged binder's asphaltene/maltene ratio towards its original state (Asli et al., “Investigation on Physical Properties of Waste Cooking Oil—Rejuvenated Bitumen Binder,” Constr. Build. Mater. 37:398-405(2012); Chen et al., “Physical, Chemical and Rheological Properties of Waste Edible Vegetable Oil Rejuvenated Asphalt Binders,” Constr. Build. Mater. 66:286-298 (2014); Chen et al., “High Temperature Properties of Rejuvenating Recovered Binder with Rejuvenator, Waste Cooking and Cotton Seed Oils,” Constr. Build. Mater. 59:10-16 (2014); D'Angelo et al., “Asphalt Binder Modification with Re-Refined Heavy Vacuum Distillation Oil (RHVDO),” Fifty-Seventh Annual Conference of the Canadian Technical Asphalt Association (CTAA) (2012); Johnson et al., “Effect of Waste Engine Oil Residue on the Quality and Durability of SHRP MRL Binders,” Transportation Research Board 93rd Annual Meeting (2014); Romera et al, “Rheological Aspects of the Rejuvenation of Aged Bitumen,” Rheol. Acta 45(4):474-478 (2006); Zargar et al., “Investigation of the Possibility of Using Waste Cooking Oil as a Rejuvenating Agent for Aged Bitumen,” J. Hazard. Mater. 233-234: 254-258(2012)) or take a stiff binder and modify the binder's asphaltene/maltene ratio and restoring it into a usable binder. Over the past several years the use of rejuvenators for restoring asphalt binder properties to their original state in RAP has increased in hot mix asphalt (HMA) (Shen et al., “Effects of Rejuvenating Agents on Superpave Mixtures Containing Reclaimed Asphalt Pavement,” J. Mater. Civ. Eng. 19(5):376-384 (2007)). Current research with RAP extracted and recovered binder has historically shown that as the dosage of a rejuvenator increases critical high and low temperatures used for determining the performance grade (PG) decrease linearly (Ma et al., “Compound Rejuvenation of Polymer Modified Asphalt Binder,” J. Wuhan Univ. Technol.—Mater. Sci. Ed. 25(6):1070-1076 (2010); Shen et al, “Determining Rejuvenator Content for Recycling Reclaimed Asphalt Pavement by SHRP Binder Specifications,” Intl. J. Pavement Eng. 3(4):261-268 (2002); Tran et al., “Effect of Rejuvenator on Performance Properties of HMA Mixtures with High RAP and RAS Contents,” National Center for Asphalt Technology (2012)). Other research has shown that it is not only possible to restore RAP extracted and recovered binder to its virgin binder performance grade, but to an even better PG (Zaumanis et al., “Determining Optimum Rejuvenator Dose for Asphalt Recycling Based on Superpave Performance Grade Specifications,” Constr. Build. Mater. 69(0):159-166 (2014)). Due to increased use of RAP in HMA construction over the past several years, demand for more economical and good performing rejuvenators has increased such as recycled motor oil (RO). RO has been shown to lower permanent deformation over time and decrease mixing and compaction temperatures in RAP extracted and recovered binder (Romera et al, “Rheological Aspects of the Rejuvenation of Aged Bitumen,” Rheol. Acta 45(4):474-478 (2006)). Most rejuvenators currently in the market act as softening agents on stiffness of RAP in the short term, but do little for improving long term performance of RAP mixtures (Tran et al., “Effect of Rejuvenator on Performance Characteristics of High RAP Mixture,” Assoc. of Asphalt Paving Technologists 257-287 (2016; Cooper Jr. et al., “Asphalt Mixtures Containing RAS and/or RAP: Relationships Amongst Binder Composition Analysis and Mixture Intermediate Temperature Cracking Performance,” Assoc. of Asphalt Paving Technologists 288-318 (2016)). There is high demand for materials that act as rejuvenators, chemicals that modify the asphalt binder composition, of RAP and RAS, as well as stiff asphalt binders from refineries. Moreover, due the increase demand of these materials in emerging markets the availability of these materials and thermoplastics for asphalt modification has been decreasing. Along with the price fluctuation of crude oil, as well as concern about sustainability, has led researchers to evaluate monomeric building blocks based on renewable feedstock to modify asphalt pavements.

The present application is directed to overcoming these and other deficiencies in the art.

### SUMMARY

One aspect of the present application relates to a composition that includes a polymer comprising two or more units of monomer A, with monomer A being a radically polymerizable plant oil, animal oil, synthetic triglyceride, or mixture thereof and an epoxidized vegetable oil, an epoxidized fatty acid, or an epoxidized fatty ester.

Another aspect of the present application relates to a composition. The composition includes a polymer comprising two or more units of monomer A, with monomer A being a radically polymerizable plant oil, animal oil, synthetic triglyceride, or mixture thereof, an epoxidized vegetable oil, an epoxidized fatty acid, or an epoxidized fatty ester; and an asphalt polymer modifier. The composition further includes a cross-linker; and an asphalt portion.

Another aspect of the present application relates to a method of producing a liquid cement composition. The method includes providing a polymer comprising two or more units of monomer A, with monomer A being a radically polymerizable plant oil, animal oil, synthetic triglyceride, or mixture thereof; providing an epoxidized vegetable oil, an epoxidized fatty acid, or an epoxidized fatty ester; and mixing the polymer with the epoxidized vegetable oil, the epoxidized fatty acid, or the epoxidized fatty ester to produce a liquid cement composition.

Another aspect of the present application relates to a method of paving. The method includes (a) providing the composition as described herein; (b) mixing the composition with a mineral aggregate to form a mixture; (c) applying the mixture to a surface to be paved to form an applied paving material, and (d) compacting the applied paving material to form a paved surface.

High oleic soybean oil (HOSO) has been polymerized in order to produce a non-cross linked, linear, or lightly branched thermoplastic elastomeric polymers at room temperature. These vegetable oil-based polymers did not contain styrenic blocks, however, when added to SBS modified asphalt, they enhanced the effectiveness of the styrenic based thermoplastics elastomers to modify the Performance Grade (PG) of the asphalt, thus reducing the total amount of SBS needed to modify the asphalt blends. It was found that, when the epoxidized and sub-epoxidized vegetable oils were added to asphalt, they improved low temperature performance drastically more than they lowered the high temperature performance, consequently there was not a linear shift in stiffness and changes in viscoelastic properties. These oils were also able to produce a liquid polymer cement, by solubilizing SBS polymers without the use of high temperatures and/or high shearing, normally required to solubilize these polymers in the asphalt. This discovery eliminates the use of the high temperature/high shear process at the asphalt terminal, as the liquid asphalt cement (LAC) can be added directly by the contractor, (see FIG. 2), effectively reducing the time and energy needed to make homogenous polymer/asphalt blends.

The technology described in the present application allows for the complete transformation of stiff binders into base binders and other commonly used PG grades. It also allows the use of higher amounts of recycled asphalt pavement and recycled asphalt shingles in hot mix asphalt. It allows contractors to recycle higher amounts of aged asphalt materials and save on costs as well as be more environmentally friendly.

The technology described in the present application enhances the properties of SBS in the asphalt, thus reducing the amount of material needed to reach certain performance grade.

The technology described in the present application reduces the time and energy required to created PMAC, by pre-solubilizing the SBS polymers into a bio-based solvent (EMS/SESO) which can be added directly to the asphalt at the contractor side and not at the asphalt terminals, as it is commonly done, see FIG. 3.

The present application describes a liquid cement that can include a sub-epoxidized vegetable oil or an epoxidized fatty acid and a high-oleic soybean oil based thermoplastic elastomer (PAEHOSO), and can optionally include an SBS polymer, sulfur compound, and an asphalt portion that can be: a polymer modified asphalt cement (PMAC), VTB, RAP, or a virgin binder. Sub-epoxidized vegetable oils or the epoxidized fatty acids are able to act as a solvent of SBS polymers and of oxidized asphalts (i.e. RAP). This liquid cement enhances the effects of SBS polymers by improving on the Multiple Stress Creep Recovery test, lowers the high temperature performance grade of the asphalt, it increases the utilization of VTB and RAP, and eliminates the need for terminal blending.

### BRIEF DESCRIPTION OF THE DRAWINGS

FIG. 1 is a schematic diagram showing the commonly used process to make polymer modified asphalt cement (PMAC).

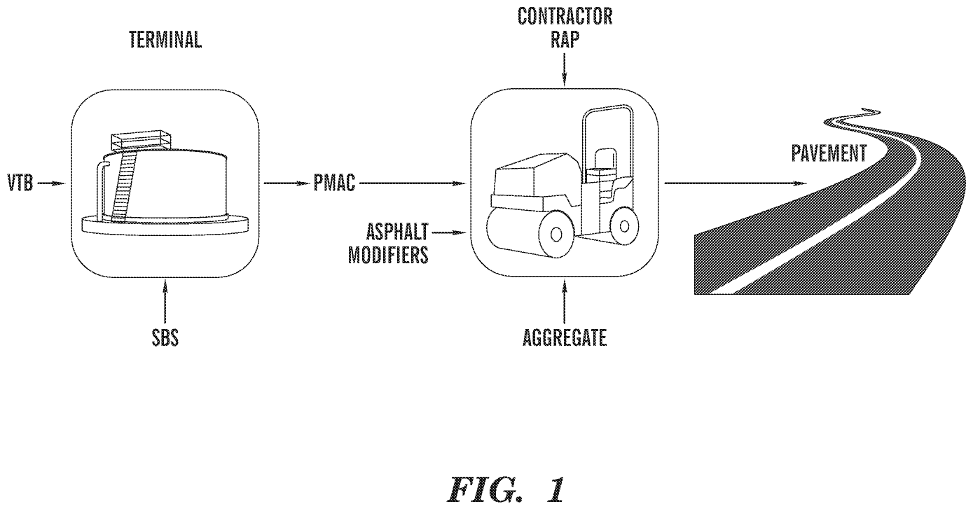

FIG. 2 is a schematic diagram showing the process of making polymer modified asphalt cement (PMAC) in accordance with the present application.

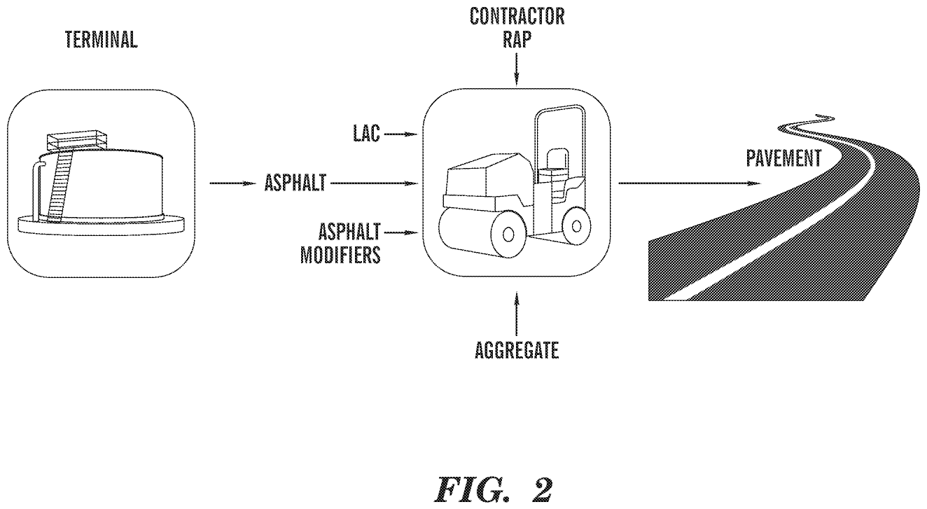

FIG. 3 is a schematic diagram showing the benefit of making polymer modified asphalt cement (PMAC) in accordance with the present application.

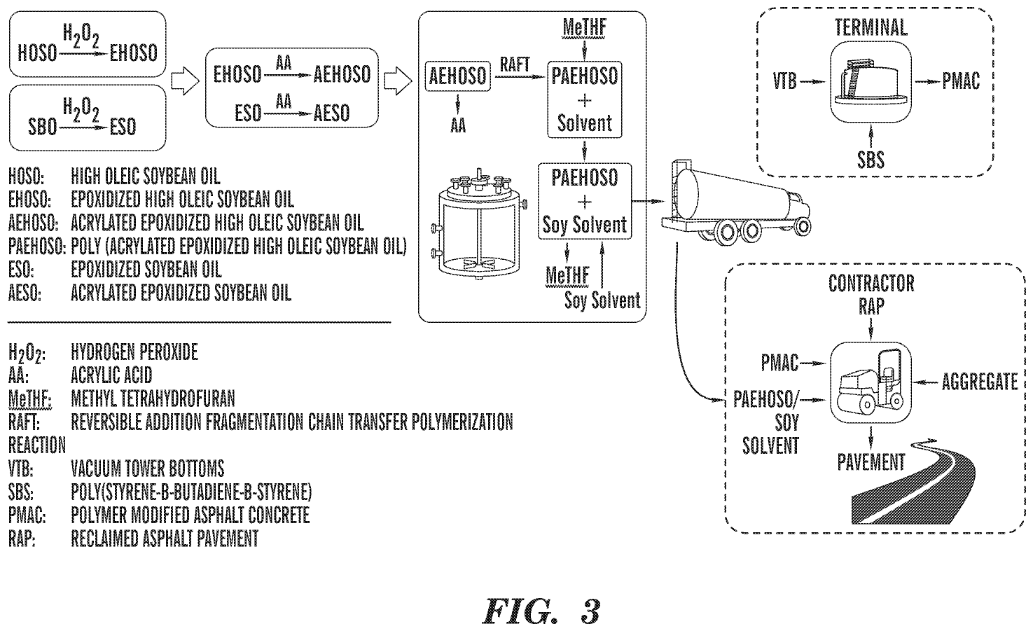

### DETAILED DESCRIPTION

One aspect of the present application relates to a composition that includes a polymer comprising two or more units of monomer A, with monomer A being a radically polymerizable plant oil, animal oil, synthetic triglyceride, or mixture thereof and an epoxidized vegetable oil, an epoxidized fatty acid, or an epoxidized fatty ester.

Renewable source-derived fats and oils comprise glycerol triesters of fatty acids. These are commonly referred to as “triglycerides” or “triacylglycerols (“TAG”).” Fats and oils are usually denoted by their biological source and contain several different fatty acids typical for each source. For example, the predominant fatty acids of soybean oil are the unsaturated fatty acids oleic acid, linoleic acid, and linolenic acid, and the saturated fatty acids palmitic acid and stearic acid. Other fatty acids are present at low levels. Triglycerides are the main component of natural oils and are composed of three fatty acids groups connected by a glycerol center. Epoxidized triglycerides can be found as such in nature, for instance in Vernonia plants, or can be conveniently synthesized from more common unsaturated oils by using a standard epoxidation process. See U.S. Patent Publ. No. 20120156484 to Vendamme et al., which is hereby incorporated by reference in its entirety.

Unsaturated fatty acids are susceptible to epoxidation to form fatty acids bearing epoxide rings. Thus, triglycerides containing unsaturated fatty acids can be subjected to epoxidation to form epoxidized triglycerides in which one, two, or all three fatty acids bear at least one epoxide ring. Diglycerides (diacylglycerols, “DAG”) are obtained when one fatty acid is removed from a triglyceride, typically by hydrolysis; monoglycerides (monoacylglycerols, “MAG”) are obtained when two fatty acids are removed from a triglyceride.

In addition, triglyceride oils have long been subjected to a process called “blowing” to make blown oils. In this process, the triglycerides are heated in the presence of air or oxygen (often blown through the oil). The double bonds of the fatty acids in the oils react to form both epoxides and dimers of the oils. The epoxidized crosslinked oil can be subjected to hydrogenation (a common vegetable oil process for removing double bonds from oils) to yield asphalt modifiers.

Renewable source derived fats and oils include algal oil, animal fat, beef tallow, borneo tallow, butterfat, camelina oil, candlefish oil, canola oil, castor oil, cocoa butter, cocoa butter substitutes, coconut oil, cod-liver oil, colza oil, coriander oil, corn oil, cottonseed oil, false flax oil, flax oil, float grease from wastewater treatment facilities, hazelnut oil, hempseed oil, herring oil, illipe fat, jatropha oil, kokum butter, lanolin, lard, linseed oil, mango kernel oil, marine oil, meadowfoam oil, menhaden oil, microbial oil, milk fat, mowrah fat, mustard oil, mutton tallow, neat's foot oil, olive oil, orange roughy oil, palm oil, palm kernel oil, palm kernel olein, palm kernel stearin, palm olein, palm stearin, peanut oil, phulwara butter, pile herd oil, pork lard, radish oil, ramtil oil, rapeseed oil, rice bran oil, safflower oil, sal fat, salicornia oil, sardine oil, sasanqua oil, sesame oil, shea fat, shea butter, soybean oil, sunflower seed oil, tall oil, tallow, tigernut oil, tsubaki oil, tung oil, triacylglycerols, triolein, used cooking oil, vegetable oil, walnut oil, whale oil, white grease, yellow grease, and derivatives, conjugated derivatives, genetically-modified derivatives, and mixtures of any thereof.

The monomer A derived from a plant oil, animal oil, or synthetic triglyceride of the present application may be polymerized. The polymerized plant oil, animal oil, or synthetic triglyceride can be subsequently partially or fully saturated via a catalytic hydrogenation post-polymerization. The monomeric oils used in the polymer can be any triglycerides or triglyceride mixtures that are radically polymerizable. These triglycerides or triglyceride mixtures may be plant oils. Suitable plant oils include, but are not limited to, a variety of vegetable oils such as soybean oil, peanut oil, walnut oil, palm oil, palm kernel oil, sesame oil, sunflower oil, safflower oil, rapeseed oil, linseed oil, flax seed oil, colza oil, coconut oil, corn oil, cottonseed oil, olive oil, castor oil, false flax oil, hemp oil, mustard oil, radish oil, ramtil oil, rice bran oil, salicornia oil, tigernut oil, tung oil, etc., and mixtures thereof. Typical plant oils used herein includes soybean oil, linseed oil, corn oil, flax seed oil, or rapeseed oil, and the resulting epoxidized fatty acid ester is polymerized triglyceride or triglyceride derivatives. In one embodiment, the polymerized plant oil monomer is poly(soybean oil). In one embodiment, monomer A is a radically polymerizable plant oil monomer selected from the group consisting of soybean oil, corn oil, linseed oil, flax seed oil, and rapeseed oil. In one embodiment, monomer A is a high oleic soybean oil.

Typical compositions of several exemplary vegetable oils are shown in Table A.

TABLE A
Typical compositions of vegetable oils.

| | Linoleic | Polyunsat- | Monounsat- | Saturated |
|---|---|---|---|---|
| Vegetable oil | acid (%) | urated (%) | urated (%) | (%) |
| Soybean | 54 | 63 | 22 | 15 |
| Safflower | 78 | 78 | 13 | 9 |
| Sunflower | 75 | 75 | 14 | 11 |
| Walnut | 64 | 64 | 22 | 14 |
| Corn | 59 | 60 | 27 | 13 |
| Sesame | 43 | 43 | 43 | 14 |
| Peanut | 31 | 31 | 51 | 18 |

Vegetable oils and animal fats are mixtures of triglycerides. A representative structure of a triglyceride is shown as below:

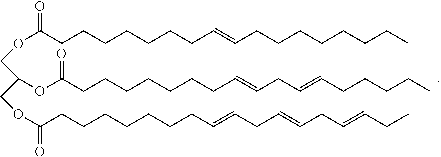 [SMILES: CC/C=C/C/C=C/C/C=C/CCCCCCCC(=O)OCC(COC(=O)CCCCCCC/C=C/CCCCCCCC)OC(=O)CCCCCCC/C=C/C/C=C/CCCCC]

A typical triglyceride structure contains a number of double bonds that may serve as candidates for polymerization. Various soybean cultivars express a variety of triglyceride compositions in their oils. Different strains of soybeans may be appropriately selected based on the triglyceride compositions to enhance the block copolymer yield and properties.

Soybean Oil (“SBO”) is the most abundant vegetable oil, which accounts for almost 30% of the world's vegetable oil supply. SBO is particularly suitable for polymerization, because it possesses multiple carbon-carbon double bonds that allow for modifications such as conjugation of the double bonds, etc.

In unprocessed oils, the double bonds contained in triglycerides are typically located in the middle of the alkyl chains and have limited reactivity towards propagation reactions due to steric hindrance and unfavorable stability of the free radical. This reactivity improves dramatically when the double bonds are conjugated (Li et al., “Soybean Oil-Divinylbenzene Thermosetting Polymers: Synthesis, Structure, Properties and their Relationships,” Polymer 42(4):1567-1579 (2001); Henna et al., “Biobased Thermosets from Free Radical Copolymerization of Conjugated Linseed Oil,” Journal of Applied Polymer Science 104:979-985 (2007); Valverde et al., “Conjugated Low-Saturation Soybean Oil Thermosets: Free-Radical Copolymerization with Dicyclopentadiene and Divinylbenzene,” Journal of Applied Polymer Science 107:423-430 (2008); Robertson et al., “Toughening of Polylactide with Polymerized Soybean Oil,” Macromolecules 43:1807-1814 (2010), which are hereby incorporated by reference in their entirety). The conjugation of double bonds in triglycerides may be readily achieved to nearly 100% conversion with homogeneous Rh catalysis (Larock et al., “Preparation of Conjugated Soybean Oil and Other Natural Oils and Fatty Acids by Homogeneous Transition Metal Catalysis,” Journal of the American Oil Chemists' Society 78:447-453 (2001), which is hereby incorporated by reference in its entirety).

The plant oil, animal oil, synthetic triglyceride, or mixture thereof may be derived from an animal source, for instance, animal fats. Thus, the animal oil can be polymerized from one or more monomeric animal fats containing one or more triglycerides. Examples of suitable animal fats used in accordance with the present application include, but are not limited to, beef or mutton fat such as beef tallow or mutton tallow, pork fat such as pork lard, poultry fat such as turkey and/or chicken fat, and fish fat/oil. The animal fats can be obtained from any suitable source including restaurants and meat production facilities. The triglyceride in the plant oil, animal oil, or synthetic triglyceride can comprise one or more conjugated sites.

“Triglycerides,” as defined herein, may refer to any unmodified triglycerides naturally existent in plant oil or animal oil or animal fat as well as any derivatives of unmodified triglycerides, such as synthetically derived triglycerides. The naturally existent parent oil may also contain derivatives of triglycerides, such as free fatty acids. An unmodified triglyceride may include any ester derived from glycerol with three similar or different fatty acids. Triglyceride derivatives may include any modified triglycerides that contain conjugated systems (i.e. a system of connected p-orbitals with delocalized electrons in triglycerides). In one embodiment, the polymerized triglyceride comprises one or more conjugated sites. Such conjugated systems increase the reactivity of triglycerides towards propagation reactions. Useful conjugated triglycerides include, but are not limited to, triglyceride derivatives containing conjugated double bonds or conjugated systems formed by acrylate groups. In one embodiment, the one or more conjugated sites are formed by acrylate groups. In another embodiment, the triglyceride is an acrylated epoxidized triglyceride. In another embodiment, monomer A is a high oleic soybean oil or an acrylated epoxidized high oleic soybean oil.

The term “soybean oil” used herein may refer broadly to any raw soybean oil or processed soybean oil that contains at least one form of triglyceride or its derivative suitable for the polymerization reaction of the present application. The term “conjugated soybean oil” used herein refers to any raw soybean oil or processed soybean oil containing at least one triglyceride with at least one conjugated site. Similar definitions also apply to other plant oils, animal oils, conjugated plant oils, conjugated animal oils, or synthetically derived triglyceride-based oils.

The conjugated triglyceride may contain one or more conjugated sites. For instance, the conjugated triglyceride may contain a single conjugated site per triglyceride. Alternatively, each fatty-acid chain of the triglyceride may contain one or more conjugated sites.

Exemplary conjugated triglycerides are:

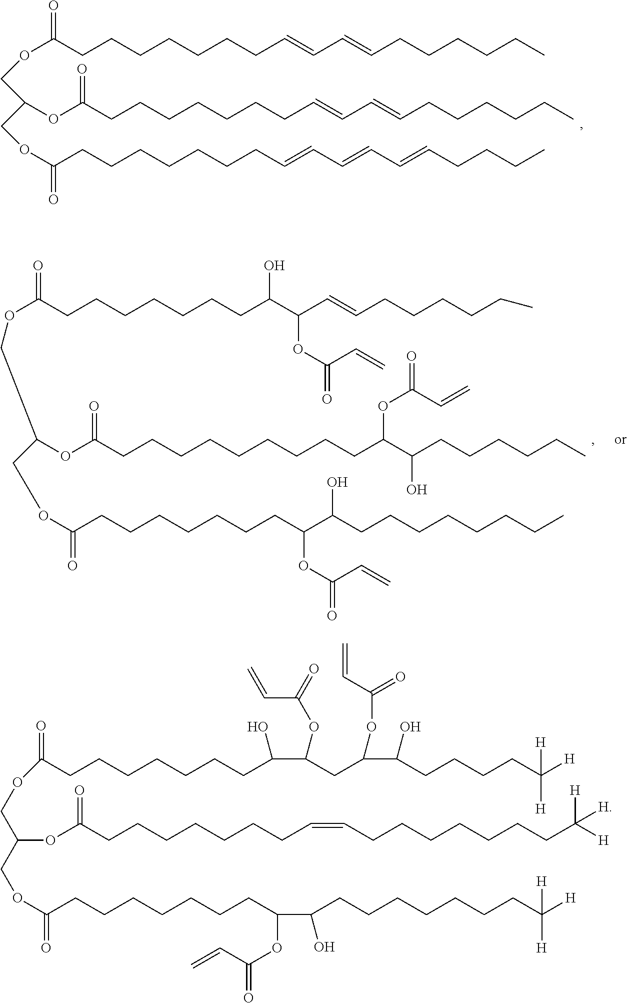

A further description of conjugation sites in soybean oil, epoxidation of soybean oil, and acrylation of soybean oil can be found in NACU BERNARDO HERNANDEZ-CANTU, “SUSTAINABILITY THROUGH BLOCK COPOLYMERS—NOVEL ION EXCHANGE CATHODE MEMBRANES AND SOYBEAN OIL BASED THERMOPLASTIC ELASTOMER,” (Iowa State University, Ames, Iowa 2012), which is incorporated herein by reference in its entirety.

In one embodiment, the conjugated plant oil or animal oil is acrylated epoxidized plant oil or animal oil, such as acrylated epoxidized soybean oil or acrylated epoxidized corn oil; the conjugated triglyceride is acrylated epoxidized triglyceride.

The polymer containing monomer A may be present in the composition in any suitable amount. For example, the polymer may be between 1 wt % and 100 wt % of the composition. The polymer may be less than about 5 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, or about 99 wt %. The range of the wt % of the polymer present in the composition may, in one embodiment, be between 10 to 90 wt %. In another embodiment, the polymer may be present in the composition in an amount of from 30 to 70 wt %.

The vegetable oil, fatty acid, and fatty esters of the present application may be modified or unmodified, partially or fully epoxidized, or partially or fully hydrogenated. In accordance with this and other aspects of the application, partially epoxidized is referred to herein as sub-epoxidized. In one embodiment, one or more of the vegetable oil, fatty acid, and fatty esters may be methylated and/or hydrogenated.

In one embodiment, the epoxidized vegetable oil, the epoxidized fatty acid, and/or the epoxidized fatty ester is selected from the group consisting of sub-epoxidized vegetable oil, sub-epoxidized fatty acid, and sub-epoxidized fatty ester. In another embodiment, the epoxidized vegetable oil, the epoxidized fatty acid, and/or the epoxidized fatty ester is selected from the group consisting of fully epoxidized fatty acid and fully epoxidized fatty ester.

Epoxidized vegetable oil, fatty acid, and fatty esters according to the present application mean that at least one of the double bonds of the unsaturated vegetable oil, fatty acid, and fatty esters is oxidized to an epoxy group. Such oxidations are well known in the art and can be readily accomplished in an industrial scale, e.g., by using hydrogen peroxide and a carboxylic acid (e.g., formate or acetate), or by the halohydrin method. It is understood by those skilled in the art that in practice, epoxidized vegetable oil, fatty acid, and fatty esters may contain various quantities of by-products arising from hydrolysis or rearrangement of epoxides and from cross-linking of the fatty acid chains. Use of epoxidized fatty acid esters containing small quantities of epoxidation by-products and epoxide decomposition by-products is included within the scope of the present disclosure. WO 2007062158 to Selifonov, which is hereby incorporated by reference in its entirety.

Epoxidized fatty acids can be subjected to esterification reactions with polyhydric alcohols (such as sugars, sugar acids, glycerol and glycols) to form epoxidized esters of polyols, or with monohydric alcohols (such as benzyl alcohol, methanol, ethanol, propanols, butanols and longer alcohols, furan-containing alcohols (such as tetrahydro-2-furanmethanol and 2-furanmethanol), glycidol, and fusel oil) to form epoxidized monoesters. Alternatively, epoxidized esters of polyols or of monohydric alcohols can be obtained by subjecting the esters to epoxidation.

Suitable epoxidized vegetable oil, epoxidized fatty acid, and epoxidized fatty esters according to the present application include, but are not limited to, epoxidized methyl soyate, epoxidized benzyl soyate, epoxidized soybean oil, epoxidized isoamyl soyate, and epoxidized corn oil. The fatty acid esters may also include, for example, epoxidized methyl linoleate; benzyl, ethyl, fusel oil, furanoic alcohols (tetrahydro-2-furanmethanol and 2-furanmethanol), glycidol, SBO TAG, DAG, MAG, glycols, and blown oils such as the above-mentioned linseed oil, rapeseed oil, castor oil and soybean oil.

Epoxidized triglycerides are commercially available. See U.S. Patent Publ. No. 20120156484 to Vendamme et al., which is hereby incorporated by reference in its entirety. For example, epoxidized linseed oil (“ELO”) is available from Cognis (Dusseldorf, Germany) under the trade name DEHYSOL B316 SPEZIAL, or Arkema (King of Prussia, Pa.) under the trade name VIKOFLEX 7190. An exemplary structure of an epoxidized triglyceride of linseed oil is as follows:

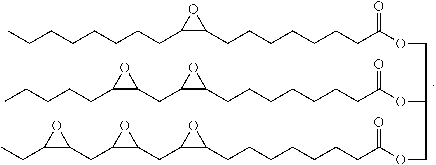 [SMILES: CCCCCCCCC1OC1CCCCCCCC(=O)OCC(COC(=O)CCCCCCCC1OC1CC1OC1CC1OC1CC)OC(=O)CCCCCCCC1OC1CC1OC1CCCCC]

Epoxidized soybean oil (“ESBO”) is commercially available from Cognis (Dusseldorf, Germany) under the trade name DEHYSOL D82, or from Arkema (King of Prussia, Pa.) under the trade name VIKOFLEX 7170. See U.S. Patent Publ. No. 20120156484 to Vendamme et al., which is hereby incorporated by reference in its entirety.

Methods of making epoxidized methyl soyate are known in the art. See U.S. Pat. No. 9,000,196 to Hagberg et al., and U.S. Pat. No. 6,797,753 to Benecke et al, both of which are hereby incorporated by reference in their entirety. Soyate relates to a mixture of fatty acids derived from soybean oil. “Methyl oleate” describes the methyl ester of only oleic acid, “methyl soyate” describes the product of the reaction of making methyl esters of soybean oil. Most biodiesel sold in the USA is just methyl soyate with a few additives.

Primary plasticizers have been reported where the plasticizers contain fatty acids derived from vegetable oils and the fatty acids are substantially fully esterified with an alcohol (monool or polyol), the fatty acids have unsaturated bonds that are substantially fully epoxidized, and the fatty acids are added substantially randomly to one or more hydroxyl sites on the alcohol. See U.S. Pat. No. 6,797,753 to Benecke et al, which is hereby incorporated by reference in its entirety. Primary plasticizers include, but are not limited to, epoxidized pentaerythritol tetrasoyate, epoxidized propylene glycol disoyate, epoxidized ethylene glycol disoyate, epoxidized methyl soyate, epoxidized sucrose octasoyate, and the epoxidized product of soybean oil interesterified with linseed oil.

There are several known methods by which these plasticizers may be made. See U.S. Pat. No. 6,797,753 to Benecke et al, which is hereby incorporated by reference in its entirety. In one embodiment, the vegetable oil fatty acids are linked by direct esterification to monoalcohols or polyalcohols, and the esterified products are then epoxidized. In an additional embodiment, the direct esterification step is replaced with transesterification, whereby the monool or polyol reacts with a lower alkyl ester of a vegetable oil fatty acid to produce the desired ester plus a lower alcohol. The ester is then epoxidized. In yet another embodiment, a first ester is interesterified with a second ester, and the desired ester is again epoxidized.

Epoxidized fatty acid esters useful as primary plasticizers in a phthalate-free system and which are suitably nonvolatile, not petroleum-based, and capable of imparting thermal stability to formulations presently using phthalate plasticizers, including those based on PVC, other halogenated polymers, acid-functionalized polymers, anhydride-functionalized polymers, and nitrile rubbers are known in the art and described in WO 2009/102877 to Eaton, which is hereby incorporated by reference in its entirety.

Suitable epoxidized fatty acid ester plasticizers may include epoxidized biodiesel (conventionally, fatty acid methyl esters of soy, rapeseed or palm oils, though C₁-C₁₄ esters are more generally contemplated) and epoxidized derivatives of fatty acid esters of biodiesel. Methods for making the epoxidized fatty acid esters involve formation of the fatty acid ester first, followed by epoxidation of the ester.

Epoxidized methyl soyate esters are known to those skilled in the art to be made starting from epoxidized soybean oil by alcoholysis, see U.S. Pat. No. 3,070,608 to Kuester et al., which is hereby incorporated by reference in its entirety. For example, epoxidized soybean oil may be reacted with a molar excess of methanol in the presence of sodium methoxide as a catalyst, to produce epoxidized methyl soyate. The total epoxide content in going from epoxidized soybean oil to epoxidized methyl soyate, as being relatively unchanged showing little or no decrease.

Reduced color epoxidized fatty acid esters according to the present application can be made from an epoxidized natural fat or oil (such as epoxidized high oleic soybean oil) through the inclusion of borohydride in either a transesterification process or in an interesterification process. See U.S. Patent Publ. No. 2014/0113999 to Howard et al., which is hereby incorporated by reference in its entirety.

In accordance with the present application, the addition of the borohydride and starting from an epoxidized natural fat or oil does not to detract in a material way from the other commercially-relevant performance attributes of a plasticized polymer composition incorporating such a reduced color epoxidized fatty acid ester, as compared to an equivalent composition prepared using an epoxidized fatty acid ester made according to the methods known in the art. Given the indication in WO 2009/102877 to Eaton, which is hereby incorporated by reference in its entirety, that epoxides made from esters of fatty acids such as the epoxidized methyl ester of soy oil are often too volatile to serve as useful plasticizers of PVC, this was a finding of considerable significance for the specific reduced color epoxidized fatty acid ester. Rather than being dependent on the production economics or availability of biodiesel, which are in turn to some extent dependent on fuels demand, pricing and usage patterns, epoxidized fatty acid esters could be made with an available supply of epoxidized soybean oil—the supply and demand for which is at least to some extent related to demand for the same plasticized PVC compositions.

Alternatively, epoxidized fatty acid esters (especially of benzyl alcohol) of the present application can be made from fats or oils by the process of transesterifying a low moisture epoxidized natural fat or oil by combination with a first alcohol in the presence of a transesterification catalyst and under conditions which are effective for carrying out the transesterification reaction. After the resultant product mixture from the reaction of the first alcohol and low moisture epoxidized natural fat or oil phase separates into an epoxidized fatty acid ester phase and a second phase comprising byproduct glycerol, the second phase is substantially removed. The epoxidized fatty acid esters in the epoxidized fatty acid ester phase from the first transesterification step are combined with more of the first alcohol and with a second alcohol which includes 5 to 7 members in a ring structure in the presence of a transesterification catalyst and under conditions effective for forming epoxidized fatty acid esters of the second alcohol in a second transesterification step. The first alcohol is continuously removed during the second transesterification step. See U.S. Patent Publ. No. 2015/0225358 to Howard et al., which is hereby incorporated by reference in its entirety. Sodium borohydride may also be incorporated into the process to make lighter materials, if necessary.

Epoxidized fatty acid esters of the present application, particularly benzyl esters, may be in the form of a composition comprising one or more unsaturated fatty acid esters of alcohols which include a five to seven member ring structure.

In one embodiment, the epoxidized vegetable oil, the epoxidized fatty acid, or the epoxidized fatty ester is a compound of Formula (I):

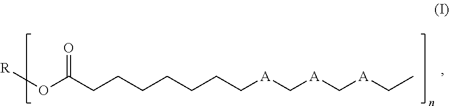

wherein: each A is independently selected at each occurrence thereof from the group consisting of a bond,

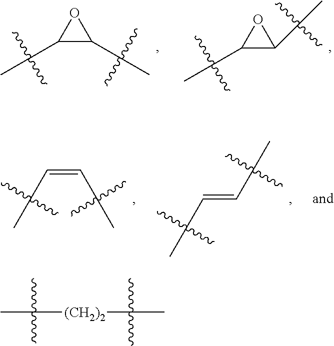

and wherein at least one A is

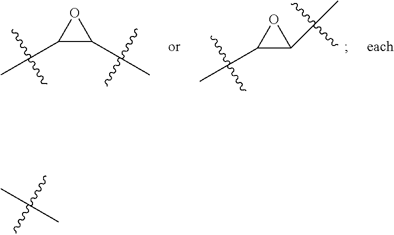

represents the point of attachment to a —CH₂— group; n is 1, 2, or 3; R is independently selected at each occurrence thereof from the group consisting of H, C₁-C₂₃ alkyl, and arylalkyl, wherein the C₁-C₂₃ alkyl can be optionally substituted with an aryl, heteroaryl, or heterocyclyl; or R is independently selected at each occurrence thereof from the group consisting of

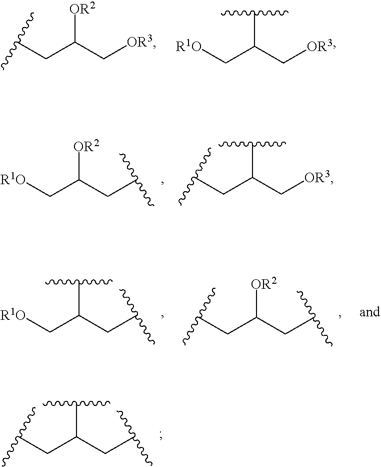

each

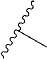

represents the point of attachment to a

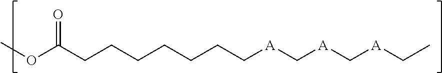

moiety; R¹, R², and R³ are independently selected at each occurrence thereof from the group consisting of —H and —C(O)R⁴; and R⁴ is independently selected at each occurrence thereof H, C₁-C₂₃ alkyl, or aryl.

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

The term “alkyl” means an aliphatic hydrocarbon group which may be straight or branched having about 1 to about 23 carbon atoms in the chain. For example, straight or branched carbon chain could have 1 to 10 carbon atoms. Branched means that one or more lower alkyl groups such as methyl, ethyl or propyl are attached to a linear alkyl chain. Exemplary alkyl groups include methyl, ethyl, n-propyl, i-propyl, n-butyl, t-butyl, n-pentyl, and 3-pentyl.

The term “benzyl” means a benzyl group as shown below

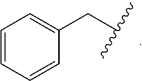 [SMILES: *Cc1ccccc1]

The term “aryl” means an aromatic monocyclic or multicyclic ring system of 6 to about 14 carbon atoms, preferably of 6 to about 10 carbon atoms. Representative aryl groups include phenyl and naphthyl.

The term “arylalkyl” means an alkyl substituted with one or more aryl groups, wherein the alkyl and aryl groups are as herein described. One particular example is an arylmethyl or arylethyl group, in which a single or a double carbon spacer unit is attached to an aryl group, where the carbon spacer and the aryl group can be optionally substituted as described herein. Representative arylalkyl groups include

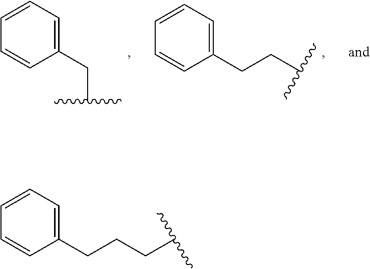 [SMILES: *Cc1ccccc1 ; *CCc1ccccc1 ; *CCCc1ccccc1]

The term “heteroaryl” means an aromatic monocyclic or multicyclic ring system of about 5 to about 14 ring atoms, preferably about 5 to about 10 ring atoms, in which one or more of the atoms in the ring system is/are element(s) other than carbon, for example, nitrogen, oxygen, or sulfur. In the case of multicyclic ring system, only one of the rings needs to be aromatic for the ring system to be defined as “Heteroaryl”. Preferred heteroaryls contain about 5 to 6 ring atoms. The prefix aza, oxa, thia, or thio before heteroaryl means that at least a nitrogen, oxygen, or sulfur atom, respectively, is present as a ring atom. A nitrogen atom of a heteroaryl is optionally oxidized to the corresponding N-oxide. Representative heteroaryls include pyridyl, 2-oxo-pyridinyl, pyrimidinyl, pyridazinyl, pyrazinyl, triazinyl, furanyl, pyrrolyl, thiophenyl, pyrazolyl, imidazolyl, oxazolyl, isoxazolyl, thiazolyl, isothiazolyl, triazolyl, oxadiazolyl, thiadiazolyl, tetrazolyl, indolyl, isoindolyl, benzofuranyl, benzothiophenyl, indolinyl, 2-oxoindolinyl, dihydrobenzofuranyl, dihydrobenzothiophenyl, indazolyl, benzimidazolyl, benzooxazolyl, benzothiazolyl, benzoisoxazolyl, benzoisothiazolyl, benzotriazolyl, benzo[1,3]dioxolyl, quinolinyl, isoquinolinyl, quinazolinyl, cinnolinyl, pthalazinyl, quinoxalinyl, 2,3-dihydro-benzo[1,4]dioxinyl, benzo[1,2,3]triazinyl, benzo[1,2,4]triazinyl, 4H-chromenyl, indolizinyl, quinolizinyl, 6aH-thieno[2,3-d]imidazolyl, 1H-pyrrolo[2,3-b]pyridinyl, imidazo[1,2-a]pyridinyl, pyrazolo[1,5-a]pyridinyl, [1,2,4]triazolo[4,3-a]pyridinyl, [1,2,4]triazolo[1,5-a]pyridinyl, thieno[2,3-b]furanyl, thieno[2,3-b]pyridinyl, thieno[3,2-b]pyridinyl, furo[2,3-b]pyridinyl, furo[3,2-b]pyridinyl, thieno[3,2-d]pyrimidinyl, furo[3,2-d]pyrimidinyl, thieno[2,3-b]pyrazinyl, imidazo[1,2-a]pyrazinyl, 5,6,7,8-tetrahydroimidazo[1,2-a]pyrazinyl, 6,7-dihydro-4H-pyrazolo[5,1-c][1,4]oxazinyl, 2-oxo-2,3-dihydrobenzo[d]oxazolyl, 3,3-dimethyl-2-oxoindolinyl, 2-oxo-2,3-dihydro-1H-pyrrolo[2,3-b]pyridinyl, benzo[c][1,2,5]oxadiazolyl, benzo[c][1,2,5]thiadiazolyl, 3,4-dihydro-2H-benzo[b][1,4]oxazinyl, 5,6,7,8-tetrahydro-[1,2,4]triazolo[4,3-a]pyrazinyl, [1,2,4]triazolo[4,3-a]pyrazinyl, 3-oxo-[1,2,4]triazolo[4,3-a]pyridin-2(3H)-yl, and the like.

As used herein, “heterocyclyl” or “heterocycle” refers to a stable 3- to 18-membered ring (radical) which consists of carbon atoms and from one to five heteroatoms selected from the group consisting of nitrogen, oxygen and sulfur. For purposes of this application, the heterocycle may be a monocyclic, or a polycyclic ring system, which may include fused, bridged, or spiro ring systems; and the nitrogen, carbon, or sulfur atoms in the heterocycle may be optionally oxidized; the nitrogen atom may be optionally quaternized; and the ring may be partially or fully saturated. Examples of such heterocycles include, without limitation, oxiranyl, azepinyl, azocanyl, pyranyl dioxanyl, dithianyl, 1,3-dioxolanyl, tetrahydrofuryl, dihydropyrrolidinyl, decahydroisoquinolyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, 2-oxoazepinyl, oxazolidinyl, oxiranyl, piperidinyl, piperazinyl, 4-piperidonyl, pyrrolidinyl, pyrazolidinyl, thiazolidinyl, tetrahydropyranyl, thiamorpholinyl, thiamorpholinyl sulfoxide, and thiamorpholinyl sulfone. Further heterocycles and heteroaryls are described in Katritzky et al., eds., Comprehensive Heterocyclic Chemistry: The Structure, Reactions, Synthesis and Use of Heterocyclic Compounds, Vol. 1-8, Pergamon Press, N.Y. (1984), which is hereby incorporated by reference in its entirety.

The term “monocyclic” used herein indicates a molecular structure having one ring.

The term “polycyclic” or “multi-cyclic” used herein indicates a molecular structure having two or more rings, including, but not limited to, fused, bridged, or spiro rings.

The term “epoxide” or “oxirane” includes an epoxide ring (i.e., group) as shown below:

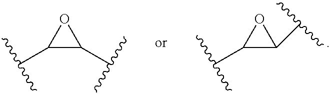 [SMILES: *C1OC1* ; *C1OC1*]

The term “substituted” or “substitution” of an atom means that one or more hydrogen on the designated atom is replaced with a selection from the indicated group, provided that the designated atom's normal valency is not exceeded.

“Unsubstituted” atoms bear all of the hydrogen atoms dictated by their valency. When a substituent is keto (i.e., ═O), then two hydrogens on the atom are replaced. Combinations of substituents and/or variables are permissible only if such combinations result in stable compounds; by “stable compound” or “stable structure” is meant a compound that is sufficiently robust to survive isolation to a useful degree of purity from a reaction mixture, and formulation into an efficacious therapeutic agent.

The term “optionally substituted” is used to indicate that a group may have a substituent at each substitutable atom of the group (including more than one substituent on a single atom), provided that the designated atom's normal valency is not exceeded and the identity of each substituent is independent of the others. Up to three H atoms in each residue are replaced with alkyl, halogen, haloalkyl, hydroxy, loweralkoxy, carboxy, carboalkoxy (also referred to as alkoxycarbonyl), carboxamido (also referred to as alkylaminocarbonyl), cyano, carbonyl, nitro, amino, alkylamino, dialkylamino, mercapto, alkylthio, sulfoxide, sulfone, acylamino, amidino, phenyl, benzyl, heteroaryl, phenoxy, benzyloxy, or heteroaryloxy.

Compounds described herein may contain one or more epoxide (oxirane) rings, and unless specified otherwise, it is intended that the compounds include both cis- or trans-isomers and mixtures thereof. When the compounds described herein contain olefinic double bonds or other centers of geometric asymmetry, and unless specified otherwise, it is intended that the compounds include both E and Z geometric isomers.

The compound of Formula (I) may include, for example, epoxidized methyl soyate (EMS), epoxidized benzyl soyate (EBS), sub-epoxidized soybean oil (SESO), epoxidized soybean oil (ESO), epoxidized isoamyl soyate, sub-epoxidized corn oil, epoxidized corn oil, sub-epoxidized rapeseed oil, epoxidized rapeseed oil, sub-epoxidized linseed oil, and epoxidized oil.

In one embodiment, the compound of Formula (I) is the compound of any one of Formulae (Ia)-(Ik) or any combination thereof:

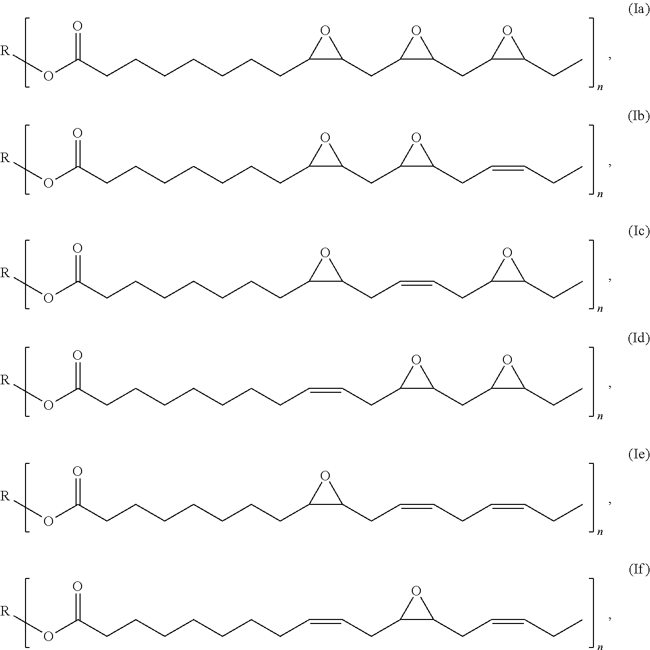

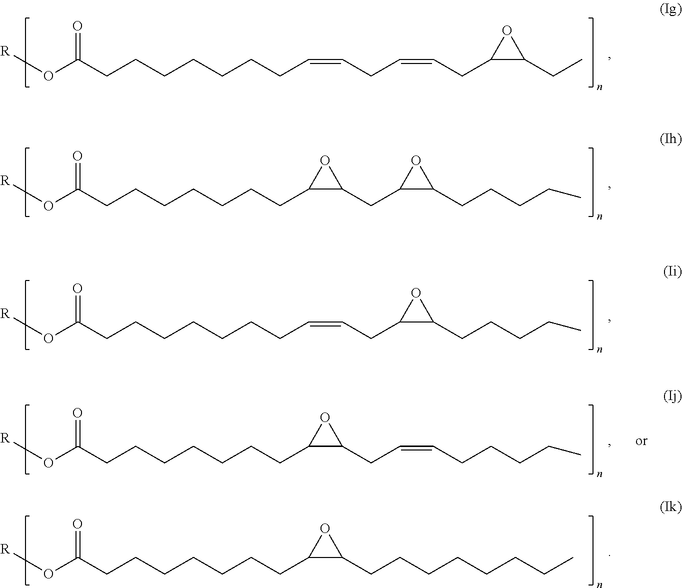

The epoxidized vegetable oil, the epoxidized fatty acid, and/or the epoxidized fatty ester may be, in some embodiments, a mixture of a vegetable oil, a fatty acid, and/or a fatty ester. The mixture may include any combination of vegetable oil, a fatty acid, and/or a fatty ester and any combination of an epoxidized vegetable oil, the epoxidized fatty acid, and/or the epoxidized fatty ester. The mixture may further include any combination of a non-epoxidized vegetable oil, non-epoxidized fatty acid, non-epoxidized fatty ester, or a mixture thereof. In one embodiment, the mixture further comprises one or more of compounds of Formulae (IIa)-(IIc):

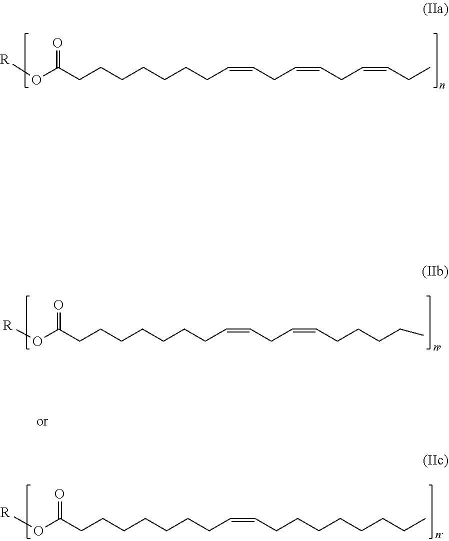

The oxirane oxygen content (also referred to herein as % oxirane oxygen or wt % of oxirane) of the compound of Formula (I) may be determined by using Official Method, Standard Cd 9-57 of the American Oil Chemists' Society (“Oxirane Oxygen in Epoxidized Materials” Official Method Cd 9-57 by the American Oil Chemist' Society (Reapproved 2017), which is hereby incorporated by reference in its entirety.

$$Oxirane oxygen , \% = \frac{mL HBr to titrate test portion \times M \times 1.60}{mass of test portion , g} \\ Where \text{-} \\ M = Molarity of HBr solution \qquad Equation 1$$

For example, oxirane oxygen content for epoxidized soybean oil may be about 7.2% and for sub-epoxidized soybean oil may be about 4.5%. The functionality is the number of epoxide groups per molecule. The functionality of epoxidized soybean oil in accordance with the present application may be approximately 4.5 and sub-epoxidized soybean oil may be approximately 2.1. The sub-epoxidized soybean oil in accordance with the present application may contain between 0.1 wt % and 10 wt % of oxirane. For example, the wt % of oxirane may be about 0.5, 1, 2, 3, 4, 5, 6, 7, 8, 9, or 10 wt %. In one embodiment, the compound of Formula (I) is a sub-epoxidized soybean oil containing 0.1-6.5 wt % of oxirane. In another embodiment, the compound of Formula (I) is a sub-epoxidized soybean oil containing 2.5-4.5 wt % of oxirane.

In one embodiment, the compound of Formula (I) is selected from the group consisting of:

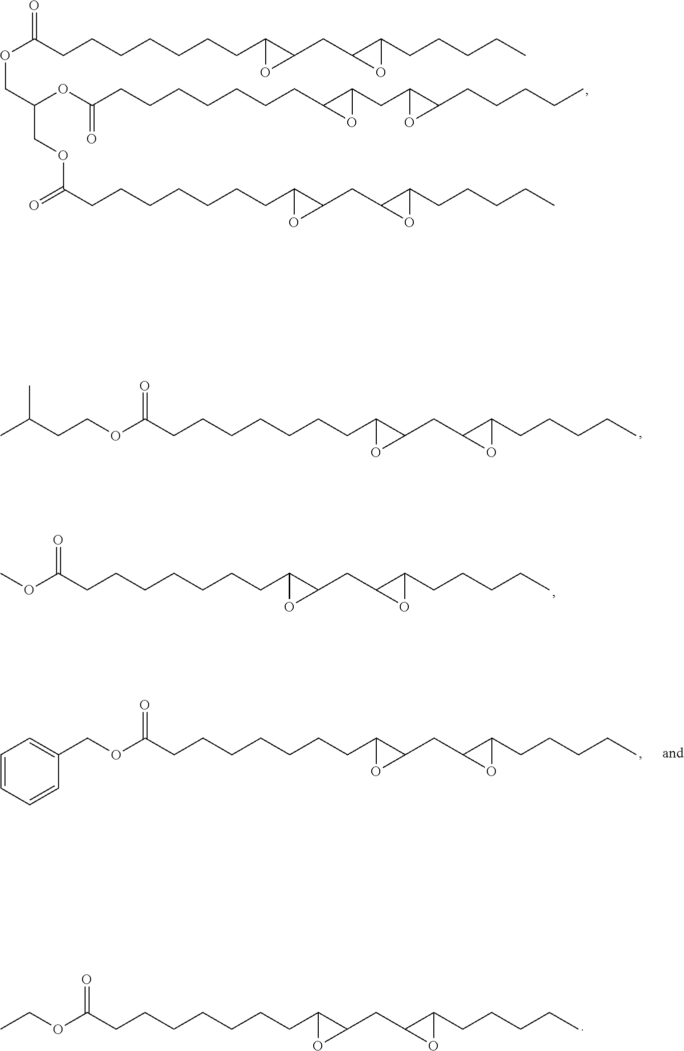

The epoxidized vegetable oil, an epoxidized fatty acid or epoxidized fatty ester may be in present in any suitable amount in the composition. The epoxidized vegetable oil, epoxidized fatty acid, and/or epoxidized fatty ester may be present anywhere between 1% to 99% of the composition. For example, the epoxidized vegetable oil, epoxidized fatty acid, and/or epoxidized fatty ester may be less than about 5 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, or about 99 wt %. The range of the wt % of the epoxidized vegetable oil, epoxidized fatty acid, and/or epoxidized fatty ester may be present in the composition between 10 to 90 wt %. In one embodiment, the epoxidized vegetable oil, epoxidized fatty acid, and/or epoxidized fatty ester is present in the composition in an amount of from 25 to 75 wt %. In another embodiment, the epoxidized vegetable oil, epoxidized fatty acid, and/or epoxidized fatty ester is present in the composition in an amount of from 30 to 55 wt %.

The composition may optionally include an asphalt polymer modifier. An asphalt polymer modifier as used in accordance with the present application include any polymer material including, for example, polyphosphoric acid (PPA), styrene/butadiene block copolymers (“SBS”), styrene/butadiene rubbers (“SBR”), styrene/isoprene block copolymers (“SIS”), ethylene/acrylate copolymers, ethylene/vinyl acetate copolymers (“EVA”), and mixtures thereof. Styrene-butadiene type polymers preferably include SB rubber, SBS linear type, SBS radial type, and SB sulphur linked type polymers, and the like. Other examples of polymers include polyethylenes, oxidized polyethylenes, polyolefins, PE homopolymers, and the like. The asphalt polymer modifier can include low molecular weight polymers, such as low, medium, or high density polyethylenes having a maximum viscosity of 1000 cps at 140° C. Other suitable asphalt polymer modifier would include ethylenes and polypropylenes with melting points below 140° C. Any suitable polymer or mixture of different polymers can be used in producing polymer-modified asphalt.

The asphalt polymer modifier, if present, may be present in any suitable amount for the composition, for example, between about 0.1 wt % to about 99 wt %, preferably between 0.1 wt % and 50 wt %. Examples of suitable amounts of an asphalt polymer include less than about 0.1 wt %, about 0.1 wt %, about 0.5 wt %, about 0.75 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 30 wt %, about 35 wt %, about 40 wt %, about 45 wt %, and about 50 wt %. The range of the asphalt polymer modifier may be, for example, between less than 0.1 wt % and 40 wt %, or between 1 wt % to about 25 wt %, or between 5 wt % and 25 wt %, or between 10 wt % and 25 wt %. In one embodiment, the asphalt polymer modifier is present in the composition in an amount of from 0.1 to 25 wt %. In another embodiment, the asphalt polymer modifier is present in the composition in an amount of from 10 to 18 wt %.

The composition may optionally further include an asphalt portion. The asphalt portion includes material in which the predominating constituents are bitumens, which occur in nature or are obtained in petroleum processing. Bitumens include solid, semisolid, or viscous substances, natural or manufactured, composed principally of high molecular weight hydrocarbons. The asphalt portion used in the present application is not particularly limited, and various kinds of asphalts may be used in the present application. Examples of the asphalt include straight asphalts such as petroleum asphalts for pavements, as well as polymer-modified asphalts produced by modifying asphalt with a polymer material including a thermoplastic elastomer such as styrene/butadiene block copolymers (SBS), styrene/isoprene block copolymers (SIS), and ethylene/vinyl acetate copolymers (EVA).

Suitable grades of asphalt include, but are not limited to, the following: PG52-22, PG58-22, PG64-22, PG67-22, PG70-22, PG76-22, PG82-22, PG52-28, PG58-28, PG64-28, PG67-28, PG70-28, PG76-28, PG52-34, PG58-34, PG64-34, PG64-16, PG67-16, PG70-16, PG76-16, PG64-10, PG67-10, PG70-10, PG76-10, pen grade 40-50, pen grade 60-70, pen grade 85-100, pen grade 120-150, AR4000, AR8000, AC10 grade, AC20 grade, and AC30 grade. Roberts et al., “Hot Mix Asphalt Materials, Mixture Design, and Construction,” NAPA Research and Education Foundation (2nd ed.) (1996), which is hereby incorporated by reference in its entirety.

In the present application, the term asphalt product includes a warm-melt flowable mixture of warm-mix binder of bituminous type optionally together with mineral filler. An asphalt product does not need to be roller compacted when implemented. It should thus be easily cast and spread. Examples of asphalt products include, in particular, asphalts, sealants, pavement seals and heat-sealing materials. In one embodiment, the asphalt portion is selected from the group consisting of polymer modified asphalt cement (“PMAC”), vacuum tower bottoms (“VTB”), oxidized asphalts, reclaimed asphalt pavement (“RAP”), and a virgin binder.

The composition may optionally further include a cross-linker. The cross-linker may be, for example, a thiol-based compound and an acid-based compound, preferably a sulfur compound. The cross-linker may be present in any suitable amount, for example between 0.1% and 99%. In one embodiment, the cross-linker is present in the composition in an amount between 0.1 to 0.5 wt %.

The composition may have a viscosity ranging from 500 cP to 55000 cP at 50° C. For example, the viscosity at 50° C. may range from 500 cP to 5000 cP, from 1000 cP to 4000 cP, and from 2000 cP to 3000 cP. In one embodiment, the viscosity of the composition may range from 500 cP to 10000 cP at 50° C.

In one embodiment, the composition exhibits an improved MSCR elastic recovery ranging from 4% to 97% measured at 58° C. compared to an asphalt portion alone. For example, the MSCR elastic recovery range may be about 4%, about 5%, about 10%, about 20%, about 30%, about 40%, about 50%, about 60%, about 70%, about 80%, about 90%, about 95%, or about 97% at 58° C. compared to asphalt alone.

The tests used in accordance with the present application allow for understanding the effects of polymer content, effects of crude source, and the rheological behavior of the developed blends. Prior to rheological testing, separation testing is done to assess the ability of the polymers to meet American Society for Testing and Materials (ASTM) standards. Each test may be conducted in triplicate on the same blends, which allows for analysis of variance (ANOVA) and subsequent regression analysis.

Statistical analysis of the data may be performed utilizing the chemical and physical data of the biopolymers and the rheological properties. The analysis also includes ANOVA to identify independent variables that are significant. Once the significant variables are identified, regression analysis can be conducted utilizing the significant variables to identify interactions between variables and understand their relative magnitude/effect on the dependent variable. Additional analysis of the data includes development of binder master curves for comparison of rheological properties of the binders over a range of temperatures.

In one embodiment, the composition is in the form of an asphalt mixture. The asphalt mixture may further include fiberglass and a mineral aggregate including at least one of lime dust and granular ceramic material. Mineral aggregates of the present application may include elements of less than 0.063 mm and optionally aggregates originating from recycled materials, sand with grain sizes between 0.063 mm and 2 mm and optionally grit, containing grains of a size greater than 2 mm, and optionally alumino-silicates. Aluminosilicates are inorganic compounds based on aluminium and sodium silicates or other metal such as potassium or calcium silicates. Aluminosilicates reduce the viscosity of the warm-mix and are in the form of a powder and/or granulates. The term granulates refers to mineral and/or synthetic granulates, especially coated material aggregates, which are conventionally added to bituminous binders for making mixtures of materials for road construction.

In another embodiment, the composition is used in roofing shingles. For a roofing-grade asphalt material, roofing granules can be applied to a surface of a coated base material. The roofing granules can be used for ultraviolet radiation protection, coloration, impact resistance, fire resistance, another suitable purpose, or any combination thereof. The roofing granules can include inert base particles that are durable, inert inorganic mineral particles, such as andesite, boehmite, coal slag, diabase, metabasalt, nephaline syenite, quartzite, rhyodacite, rhyolite, river gravel, mullite-containing granules, another suitable inert material, or any combination thereof. See U.S. Patent Publ. No. 2013/0160674 to Hong et al., which is hereby incorporated by reference in its entirety.

Roofing granules may also include one or more surface coatings over the shingle. The surface coating can cover at least approximately 75% of the surface of the shingle, and may cover at least approximately 90% of the surface of the shingle and may or may not have a uniform thickness. If more than one surface coating is used, a surface coating closer to the shingle can include a binder that can be inorganic or organic. An inorganic binder can include a silicate binder, a titanate binder, a zirconate binder, an aluminate binder, a phosphate binder, a silica binder, another suitable inorganic binder, or any combination thereof Δn organic binder can include a polymeric compound. In a particular embodiment, an organic binder can include an acrylic latex, polyurethane, polyester, silicone, polyamide, or any combination thereof. One or more additional organic binders of the same or different composition can be used.

A surface coating may also or alternatively include a solar reflective material that helps to reflect at least some of the solar energy. For example, UV radiation can further polymerize or harden the asphalt within roofing product being fabricated. A solar reflective material can include titanium dioxide, zinc oxide, or the like. Alternatively, the solar reflective material can include a polymeric material. In one embodiment, a polymer can include a benzene-modified polymer (e.g., copolymer including a styrene and an acrylate), a fluoropolymer, or any combination thereof. Other solar reflective materials are described in U.S. Pat. No. 7,241,500 to Shiao et al. and U.S. Publ. Nos. 2005/0072110 to Shiao et al. and 2008/0220167 to Wisniewski et al., all of which are incorporated by reference for their teachings of materials that are used to reflect radiation (e.g., UV, infrared, etc.) from the sun.

A surface coating can also or alternatively include an algaecide or another biocide to help reduce or delay the formation of algae or another organic growth. The algaecide or other biocide can include an organic or inorganic material. The algaecide or other biocide can include a triazine, a carbamate, an amide, an alcohol, a glycol, a thiazolin, a sulfate, a chloride, copper, a copper compound, zinc, a zinc compound, another suitable biocide, or any combination thereof. In a particular embodiment, the algaecide or other biocide can be included within a polymeric binder. The polymeric binder can include polyethylene, another polyolefin, an acid-containing polyolefin, ethylene vinyl acetate, an ethylene-alkyl acrylate copolymer, a polyvinylbutyral, polyamide, a fluoropolymer, an acrylic, a methacrylate, an acrylate, polyurethane, another suitable binder material, or any combination thereof. The algaecide or other biocide can be an inorganic material that is included within an inorganic binder, for example, within an alkali metal silicate binder. An exemplary inorganic algaecide or other biocide can include a metal (by itself), a metal oxide, a metal salt, or any combination thereof. The metallic element used within the metal, metal oxide, or salt may include copper, zinc, silver, or the like. The metal salt can include a metal sulfate, a metal phosphate, or the like.

A surface coating can include a colorant or another material to provide a desired optical effect. The colorant or other material can include a metal oxide compound, such as titanium dioxide (white), zinc ferrite (yellow), red iron oxides, chrome oxide (green), and ultramarine (blue), silver oxide (black), zinc oxide (dark green), or the like. In another embodiment, the colorant or other material may not be a metal-oxide compound. For example, the colorant may include carbon black, zinc or aluminum flake, or a metal nitride.

The composition may be mixed with fiberglass and mineral aggregate typically composed of lime dust and/or granular ceramic material, such as manufactured ceramic material to form roofing shingles. The shingles can also include manufactured sand, e.g., crushed and washed mined aggregate, and also a blend of ceramic material and manufactured sand. The roofing shingles can also include modified asphalt containing a Fischer-Tropsch wax, polyethylene wax, and/or oxidized polyethylene wax. Wax modifiers that can be usefully employed in the context of the present application include, but are not limited to, waxes of vegetable (e.g. carnuba wax), animal (e.g beeswax) mineral (e.g. Montan™ wax from coal, Fischer Tropsch wax from coal) or petroleum (e.g. paraffin wax, polyethylene wax, Fischer-Tropsch wax from gas) origin including oxidized waxes; amide waxes (e.g. ethylene bis stearamide, stearyl amide, stearyl stearamide); fatty acids and soaps of waxy nature (e.g., aluminum stearate, calcium stearate, fatty acids); other fatty materials of waxy nature (fatty alcohols, hydrogenated fats, fatty esters etc) with the ability to stiffen asphalt, and the like. The above products are basically soluble in the asphalt at warm mix temperatures, to make a homogeneous binder, and/or will melt at the temperature of the mix and the ingredients will disperse/dissolve into the mixture. The wax and resin ingredients will generally act to improve cohesion properties of the asphalt, while the adhesion promoter will improve the adhesion of the asphalt to the aggregate. Together the ingredients provide improved resistance to water damage. The present application may employ a Fischer Tropsch Wax derived from coal or natural gas or any petroleum feedstock. The process entails the gasification of the above feedstock by partial oxidation to produce carbon monoxide under high temperature and pressure and reaction of the resultant carbon monoxide with hydrogen under high temperature and pressure in the presence of a suitable catalyst (such as iron compound or cobalt compound) for example as in the case of processes employed by Shell and Sasol. The congealing point of the wax is between 68° C. and 120° C. with a Brookfield viscosity at 135° C. in the range of 8 to 20 cPs. For example, the congealing point of the wax may be between 80° C. and 120° C. Alternatively, the congealing point of the wax may be between 68° C. and 105° C. See U.S. Patent Publ. No. 2013/0186302 to Naidoo et al., which is hereby incorporated by reference in its entirety.

Another aspect of the present application relates to a composition. The composition includes a polymer comprising two or more units of monomer A, with monomer A being a radically polymerizable plant oil, animal oil, synthetic triglyceride, or mixture thereof, an epoxidized vegetable oil, an epoxidized fatty acid, or an epoxidized fatty ester; and an asphalt polymer modifier. The composition further includes a cross-linker; and an asphalt portion.

The characteristics of the polymer and the epoxidized vegetable oil, epoxidized fatty acid, and epoxidized fatty ester are in accordance with the previously described aspects.

In one embodiment, the composition further includes a hot-mix asphalt rejuvenator and/or a softening agent. Rejuvenators and softening agents have been successfully implemented to offset the high stiffness and low creep rate of aged recycled asphalt pavement (RAP) asphalt binder. Use of rejuvenators and/or softening agents has resulted in considerable improvement to low-temperature mix properties of mixtures with high RAP content (Hajj et al., “Influence of Hydrogreen Bioasphalt on Viscoelastic Properties of Reclaimed Asphalt Mixtures,” Transportation Research Record: Journal of the Transportation Research Board 2371:13-22 (2013); Shen et al., “Effects of Rejuvenating Agents on Superpave Mixtures Containing Reclaimed Asphalt Pavement,” Journal of Materials in Civil Engineering 19(5):376-384 (2007); and Zaumanis et al., “Influence of Six Rejuvenators on the Performance Properties of Reclaimed Asphalt Pavement (RAP) Binder and 100% Recycled Asphalt Mixtures,” Construction and Building Materials 71:538-550 (2014), which are hereby incorporated by reference in their entirety).

Rejuvenators and/or softening agents are chemical or bio-derived additives which typically contain a high proportion of maltenes, which serves to replenish the maltene content in the aged bitumen that has been lost as a result of oxidation leading to increased stiffness (Copeland, A., “Reclaimed Asphalt Pavement in Asphalt Mixtures: State of the Practice,” (2011), which is hereby incorporated by reference in its entirety). Binder aging is characterized by a change of the maltenes fraction into asphaltene through oxidation. The amount of asphaltene is related to the viscosity of asphalt. Firoozifar et al., “The Effect of Asphaltene on Thermal Properties of Bitumen,” Chemical Engineering Research and Design 89:2044-2048 (2011), which is hereby incorporated by reference in its entirety. The addition of maltenes helps rebalance the chemical composition of the aged bitumen, which contain a high percentage of asphaltenes (causing high stiffness and low creep rate). Rejuvenators and softening agents recreate the balance between the asphaltene and maltene by providing more maltenes and/or by allowing better dispersion of the asphaltenes (Elseifi et al., “Laboratory Evaluation of Asphalt Mixtures Containing Sustainable Technologies,” Journal of the Association of Asphalt Paving Technologists 80 (2011), which is hereby incorporated by reference in its entirety. Rejuvenators are added during mixing and are believed to diffuse within the aged bitumen imparting softening characteristics. The rejuvenator initially coats the outside of the RAP aggregates before they gradually seep into the aged bitumen layer until they diffuse through the film thickness (Carpenter et al., “Modifier Influence in the Characterization of Hot-Mix Recycled Material,” Transportation Research Record 777 (1980), which is hereby incorporated by reference in its entirety). In one embodiment, the hot-mix asphalt rejuvenator is Hydrolene 600T.

In one embodiment, the composition exhibits an improved low temperature PG grade ranging from 1° C. to 24° C. lower than in an asphalt portion alone. For example, the improved low temperature PG grade may be 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., or 24° C. lower than in an asphalt portion alone. In another embodiment, the composition exhibits an improved high temperature PG ranging from 0° C. to 24° C. higher than in an asphalt portion alone. For example, the improved high temperature PG grade may be 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., or 24° C. higher than in an asphalt portion alone.

Another aspect of the present application relates to a method of producing a liquid cement composition. The method includes providing a polymer comprising two or more units of monomer A, with monomer A being a radically polymerizable plant oil, animal oil, synthetic triglyceride, or mixture thereof; providing an epoxidized vegetable oil, an epoxidized fatty acid, or an epoxidized fatty ester; and mixing the polymer with the epoxidized vegetable oil, the epoxidized fatty acid, or the epoxidized fatty ester to produce a liquid cement composition.

The characteristics of the polymer and the epoxidized vegetable oil, epoxidized fatty acid, and epoxidized fatty ester are in accordance with the previously described aspects.

In one embodiment, the method further includes providing an asphalt polymer modifier and mixing the asphalt polymer modifier with the liquid cement to produce an improved liquid cement composition. The asphalt polymer modifier is consistent with the asphalt polymer modifier described in the previous aspects.

In one embodiment, the method further includes providing an asphalt portion and mixing the liquid cement composition with the asphalt portion to produce a liquid asphalt cement composition. The asphalt portion is consistent with the asphalt portion described in the previous aspects.

In one embodiment, the method further includes providing a cross-linker and mixing the liquid asphalt cement composition with the cross-linker to form a liquid asphalt cement blend composition. The cross-linker is consistent with the cross-linker described in the previous aspects.

In one embodiment, the method further includes providing a hot-mix asphalt rejuvenator and mixing the hot-mix asphalt rejuvenator with the liquid asphalt cement composition to produce a rejuvenated liquid cement composition. The characteristics of the hot-mix asphalt rejuvenator are consistent with the previously described aspects.

The mixing step may be carried out at a temperature of, for example, 150° C., 140° C., 130° C., 120° C., 110° C., 100° C., 90° C., 80° C., 70° C., 60° C., 50° C., 40° C., 30° C., 20° C., 10° C., 5° C., 4° C., 3° C., 2° C., 1° C., or any temperature in between. In one embodiment, mixing is carried out at 50-100° C.

Another aspect of the present application relates to a method of paving. The method includes (a) providing the composition as described herein; (b) mixing the composition with a mineral aggregate to form a mixture; (c) applying the mixture to a surface to be paved to form an applied paving material, and (d) compacting the applied paving material to form a paved surface.

The characteristics of the composition containing the polymer and the epoxidized vegetable oil, epoxidized fatty acid, and epoxidized fatty ester described herein are in accordance with the previously described aspects.

Both neat (unmodified) asphalt and polymer modified asphalt binders are used in highway paving applications. As used herein, polymer modified asphalt binders are used on higher volume/loading locations whereas unmodified asphalt binders are used in lower or intermediate volume/loading locations. The use of warm mix asphalt additives have been shown to be successfully used, e.g. improving the compactability, in unmodified asphalt binders. However, warm mix asphalt additives have historically shown limited compactability value for polymer modified asphalt binders.

A mineral aggregate may be added to the composition to modify its rheology and temperature susceptibility. In an alternative embodiment, the composition includes asphalt concrete used in pavement. The composition is mixed with mineral aggregate typically composed of sand, gravel, limestone, crushed stone, slag, and mixtures thereof. The mineral aggregate particles of the present application include calcium based aggregates, for example, limestone, siliceous based aggregates and mixtures thereof Δggregates can be selected for asphalt paving applications based on a number of criteria, including physical properties, compatibility with the bitumen to be used in the construction process, availability, and ability to provide a finished pavement that meets the performance specifications of the pavement layer for the traffic projected over the design life of the project.

The mixing step may be carried out at a temperature of, for example, 150° C., 140° C., 130° C., 120° C., 110° C., 100° C., 90° C., 80° C., 70° C., 60° C., 50° C., 40° C., 30° C., 20° C., 10° C., 5° C., 4° C., 3° C., 2° C., 1° C., or any temperature in between. In one embodiment, mixing is carried out at 50-100° C.

The compacting step may be carried out at a temperature of, for example, 140° C., 130° C., 120° C., 110° C., 100° C., 90° C., 80° C., 70° C., 60° C., 50° C., 40° C., 30° C., 20° C., 10° C., 9° C., 8° C., 7° C., 6° C., 5° C., 4° C., 3° C., 2° C., 1° C., or any temperature in between. In one embodiment, the compacting is carried out at 100-130° C.

The above disclosure generally describes the present application. A more specific description is provided below in the following examples. The examples are described solely for the purpose of illustration and are not intended to limit the scope of the present application. Changes in form and substitution of equivalents are contemplated as circumstances suggest or render expedient. Although specific terms have been employed herein, such terms are intended in a descriptive sense and not for purposes of limitation.

### EXAMPLES

### Example 1—Polymerization of Poly(Acrylated High Oleic Epoxidized Soybean Oil) (PAEHOSO)

Materials

2-Methyltetrahydrofuran (MeTHF), phenothazine (PTZ), methylhydroquinone (MHQ), azobisisobutyronitrile (AIBN), acrylated epoxidized high oleic soybean oil (AEHOSO), and OX-Cart.

Method

Polymerization was performed at 81° C. for a maximum of three hours using MeTHF as the solvent, MHQ as the inhibitor, AIBN as the initiator, AEHOSO as the monomer, and OX-Cart as the CTA. Two different procedures were used to produce PAEHOSO. Procedure 1 is described in Table 1 and Table 2 and procedure 2 is described in Table 3 and Table 4.

TABLE 1

| TARGET M.W. | 100,000 | Da |
|---|---|---|
| Solvent Ratio | 3 | |
| Monomer Amount | 40 | g |
| Initiator | 0.55 | g |
| AEHOSO | 2.6 | acrylics per |
| Functionality | | triglyceride |
| Inhibitor Conc. | 0.004 | |
| Reaction Temp | 80 | ° C. |
| Reaction Time | 2.5 | h |

TABLE 2

| | | | | | Weight | Volume | Actual |
|---|---|---|---|---|---|---|---|
| | Chemical | M.W. | Ratio | Moles | (g) | (ml) | Amount (g) |
| Monomer | AESBO | 1100.0 | 90.90 | 0.0360 | 40.00 | 40.40 | 40.04 |
| Initiator | AIBN - | 164.2 | 0.55 | 0.0002 | 0.04 | 0.03 | 0.64 |
| CTA | OX-CART | 1000.0 | 1.00 | 0.0004 | 0.40 | | 0.41 |
| | PS | | | | | | |
| Solvent 1 | MeTHF | 86.1 | 3.00 | 1.1898 | 102.48 | 120.00 | 103.18 |

| | | | |
|---|---|---|---|
| Total Amounts: | 142.91 | 160.43 | 144.26 |

TABLE 3

| TARGET M.W. | 1,000,000 | Da |
|---|---|---|
| Solvent Ratio | 1 | |
| Monomer Amount | 20 | g |
| Initiator | 3.25 | g |
| AEHOSO | 1.3 | acrylics per |
| Functionality | | triglyceride |
| Inhibitor Conc. | 0.004 | |
| Reaction Temp | 80 | ° C. |
| Reaction Time | 4.25 | h |

TABLE 4

| | | | | | Weight | Volume | Actual |
|---|---|---|---|---|---|---|---|
| | Chemical | M.W. | Ratio | Moles | (g) | (ml) | Amount (g) |
| Monomer | AESBO | 1100.00 | 909.09 | 0.0180 | 20.00 | 20.20 | 20.00 |
| Initiator | AIBN - | 164.21 | 3.25 | 0.0001 | 0.01 | 0.01 | 0.78 |
| CTA | OX-CART | 1000.00 | 1.00 | 0.0000 | 0.02 | | 0.02 |
| | PS | | | | | | |
| Solvent 1 | MeTHF | 86.13 | 1.00 | 0.1983 | 17.08 | 20.00 | 17.30 |

| | | | |
|---|---|---|---|
| Total Amounts: | 37.11 | 40.21 | 38.10 |

### Example 2—Liquid Cement Preparation

Materials

Epoxy benzyl soyate (EBS), epoxidized methyl soyate (EMS), sub-epoxidized soybean oil (SESO), Hydrolene 600T, elemental sulfur, poly(acrylated high oleic epoxidized soybean oil) (PAEHOSO), and SBS (411, 1118, 243).

Methods

Liquid asphalt cements were mixed using an IKA mixer at 500 RPM and 70° C.

Method 1: A set amount of PAEHOSO/EMS or SESO was heated up to 70° C. while mixing it at 500 RPM. After the mixture reached the desired temperature, the set amount of SBS polymer was added along with the set amount of Hydrolene. Mixing was performed for 5-12 hours (depending on the concentration of SBS). The final product was a homogenous liquid cement.

Method 2: A set amount of EMS or SESO were heated up to 70° C. while mixing it at 500 RPM. After the mixture reached the desired temperature, the set amount of SBS polymer was added. Mixing was performed for 5-12 hours (depending on the concentration of SBS). The final product was a homogenous SBS liquid cement.

### Example 3—Asphalt Blending

Materials

Liquid asphalt cement, asphalt binders: VTB, RAP, two different 64-22 virgin binders.

Methods

Method 1: The asphalt binder was heated to 100° C. while stirring at 100 RPM, enough time was allowed for the temperature to stabilize. The PAEHOSO/EMS/SBS, PAEHOSO/SESO/SBS, or SBS/Hydrolene was gradually added while mixing until a homogenous blend was seen. 0.0-0.5% Sulfur was then added, followed by an increase in the mixing temperature to 140° C. for 12 hours.

Method 2: The asphalt binder was heated to 140° C. while stirring at 100 RPM, enough time was allowed for the temperature to stabilize. The EMS/SBS, SESO/SBS, or SBS solution was gradually added while mixing until a homogenous blend was seen. 0.0-0.5% Sulfur was then added and the mixture mixed for 6 hours. The reaction was then cooled to 100° C. followed by the gradual addition of the PAEHOSO/EMS or PAEHOSO/SESO mixture. The mixture's temperature was then increased again to 140° C. for an additional 6 hours.

ΔT_{c} Parameter

The ΔT_{c} can be used to evaluate the potential of cracking as result from aging. The ΔT_{c} is used to measure the ductility loss of an aged binder and relate this to non-load cracking (block cracking). Block cracking is a phenomenon that is like thermal crack in how the propagation of the cracks happen, but is a related to thixotropic hardening. This internal molecular rearrangement that causes embrittlement is more related to aging and less to environment. Embrittlement directly affects the ductility of the material or bend and not break. The parameter ΔT_{c} is the difference between the critical low temperature of the stiffness and the m-value. The critical low temperatures are acquired from the BBR testing method (Rowe et al., “The Influence of Binder Rheology on the Cracking of Asphalt Mixes in Airport and Highway Projects,” Journal of Testing and Evaluation 42:1063-1072 (2014); Roberts et al., “Hot Mix Asphalt Materials, Mixture Design and Construction,” National Asphalt Pavement Association Research and Education Foundation, 2^{nd} Ed. (1996); Christensen et al., “Past, Present, and Future of Asphalt Binder Rheological Parameters,” Transportation Research Circular E-C241 88 pp (2019); “The Delta Tc Parameter: What Is It and How Do We Use It?” http://eng.auburn.edu//research/centers/ncat/newsroom/2017-spring/delta-tc, which are hereby incorporated by reference in their entirety).

ΔT_{c}=T_{continous grade (stiffness)}−T_{continous grade (m-value)} [1]

### Example 4—Results

Table 5 shows the properties of neat binders from Seneca Petroleum and Flint Hills Resources. Table 6 lists the results of the different liquid cement formulations prepared from virgin PG64-22 binder and a 50:50 wt % PAEHOSO/EMS mixture, where the PAEHOSO has a number average molecular weight of about 500 kDa. The PAEHOSO was prepared from an acrylated epoxidized high oleic soybean oil with an average of 2.2 acrylic groups per triglyceride.

TABLE 5
Properties of Virgin 64-22 Binders From Seneca
Petroleum and Flint Hills Resources

| | | Flint | |
|---|---|---|---|
| Binder | Seneca 64-22 | Hills | |
| High Temp. PG | 65.6 | 64.9 | ° C. |
| Low Temp. PG | −23.9 | −25.23 | ° C. |
| (m-value) | | | |
| Low Temp. PG | −26.04 | −24.15 | ° C. |
| (Stiffness) | | | |
| ΔT_{c} | −2.11 | 1.09 | ° C. |
| MSCR | 2.30% | 1.66% | |
| Jnr | | 1.341 | @58° C. |

TABLE 6
Properties of PG64-22 Binders Modified With PAEHSO/EMS Mixtures

| | Styrene - | | | | | | | | |
|---|---|---|---|---|---|---|---|---|---|
| | Butadiene % | | | | | Low | | | |
| Blend | by wt. of | PAEHOSO | EMS | High | Low temp | temp | | MSCR | |
| # | the binder | % | % | Temp | (Stiffness) | (m-value) | ΔT_{c} | 58° C. | Jnr |
| 1 | 2.0% Radial | | 6.0% | 62.3 | −37.02 | −32.57 | −4.45 | 21.68% | 2.252 |
| | SBS (411) | | | | | | | | |
| 2* | 2.0% Radial | 6.0% | 6.0% | 63.7 | −24.15 | −25.23 | 1.09 | 34.9% | 1.385 |
| | SBS (411) | | | | | | | | |
| 3 | 2.0% Radial | 6.0% | 6.0% | 61.1 | −34.06 | −29.06 | −5.01 | 32.74% | 1.258 |
| | SBS (411) | | | | | | | | |
| 4 | 2.0% Radial | 4.0% | 4.0% | 66.3 | −32.38 | −30.92 | −1.46 | 52.58% | 0.590 |
| | SBS (411) | | | | | | | | |
| 5** | 1.3% Radial | 4.0% | 4.0% | 64.2 | −29.20 | −26.88 | −2.32 | 19.38% | 1.441 |
| | SBS (411) | | | | | | | | |

Unless otherwise noted, the virgin binder was received from Seneca Petroleum and the modified binder formulation includes 0.2 wt % sulfur. All composition values are wt % by weight of the virgin binder.
*Flint Hills 64-22
**Contains 0.13% sulfur

The best performing blend is Blend #4 in Table 6.

Table 7 shows the virgin binder properties of an exemplary vacuum tower bottom (VTB) binder obtained from Seneca Petroleum. Table 8 lists the performance data of 5 different VTB blends modified with 0.5 w % sulfur, 5 wt % Hydroline 600T, a radial SBS at 1 or 2 wt % and a 50:50 wt % PAEHOSO/EMS mixture, where the PAEHOSO has a number average molecular weight of about 500 kDa. The PAEHOSO was prepared from an acrylated epoxidized high oleic soybean oil with an average of 2.2 acrylic groups per triglyceride. All wt % compositions are with respect to the virgin binder.

TABLE 7
Characteristics of a Virgin VTB From Seneca Petroleum

| Binder | VTB | |
|---|---|---|
| High Temp. PG | 79.9 | ° C. |
| Low Temp. PG | −14.5 | ° C. |
| (m-value) | | |
| Low Temp. PG | −17.35 | ° C. |
| (Stiffness) | | |
| ΔT_{c} | −2.83 | ° C. |

TABLE 8
Characteristics of Seneca Petroleum VTB Formulated with 0.5 wt % Sulfur, 5 wt %
Hydroline 600T, 1 or 2 wt % LG-411 Radial SBS, and 12 wt % PAEHOSO:EMS Mixture

| | Styrene - | | PAEHOSO | | | | | | |
|---|---|---|---|---|---|---|---|---|---|
| | Butadiene % | | % by wt. | | | Low | | | |
| Blend | by wt. of | | of the | High | Low temp | temp | | MSCR | |
| # | the binder | Functionality | binder | Temp | (Stiffness) | (m-value) | ΔT_{c} | 58° C. | Jnr |
| 1 | 2.0% Radial | 2.2 | 6.00% | 77.4 | −24.14 | −24.66 | 0.52 | 38.99% | 0.259 |
| | SBS (411) | | | | | | | | |
| 2 | 2.0% Radial | 2.2 | 6.00% | 75.4 | −26.16 | −27.06 | 0.90 | 37.79% | 0.317 |
| | SBS (411) | | | | | | | | |
| 3 | 1.0% Radial | 2.2 | 6.00% | 74.3 | −26.6 | −26.6 | 0.00 | 30.18% | 0.305 |
| | SBS (411) | | | | | | | | |
| 4 | 1.0% Radial | 2.2 | 6.00% | 74 | −27.03 | −24.82 | −2.21 | 26.27% | 0.423 |
| | SBS (411) | | | | | | | | |
| 5 | 1.0% Radial | 2.2 | 6.00% | 74.5 | −23.62 | −24.05 | 0.43 | 25.79% | 0.374 |
| | SBS (411) | | | | | | | | |

| | | | | | | | |
|---|---|---|---|---|---|---|---|
| 6** | No Radial SBS (411) or PAEHOSO | 65.6 | −27.12 | −26.12 | −1.00 | 1.64% | 1.41 |
| | polymers, just EMS and 600T | | | | | | |

**Does not contain sulfur**

Tables 9-10 list the MSCR/Jnr results of 3 different blends and the reproducibility amongst the samples. Blending temperature was 140° C.

TABLE 9

| | 2.2 | |
|---|---|---|
| Polymer | PAEHOSO | |
| M.W. Polymer | 500 | kDa |
| Polymer dosage | 6.00% | by weight |
| | | of binder |
| EMS | 6.00% | by weight |
| | | of binder |
| Hydroline 600T | 5.00% | by weight |
| | | of binder |
| Binder | VTB | |
| High Temp. PG | 79.9 | ° C. |
| Low Temp. PG | −14.5 | ° C. |
| (m-value) | | |
| Low Temp. PG | −17.35 | ° C. |
| (Stiffness) | | |
| ΔT_{c} | −2.83 | ° C. |

TABLE 10

| | Styrene - | | | | | | | |
|---|---|---|---|---|---|---|---|---|
| | Butadiene % | | | | Low | | | |
| Blend | by wt. of | Sulfur | High | Low temp | temp | | MSCR | |
| # | the binder | dosage | Temp | (Stiffness) | (m-value) | ΔT_{c} | 58° C. | Jnr |
| 1 | 2.0% Radial | 0.50% | 77.4 | −24.14 | −24.66 | 0.52 | 38.99% | 0.259 |
| | SBS (411) | | | | | | | |
| 2 | 2.0% Radial | 0.20% | 75.4 | −25.88 | −25.25 | −0.63 | 27.19% | 0.317 |
| | SBS (411) | | | | | | | |
| 3 | 2.0% Radial | 0.05% | 70.1 | −25.56 | −25.23 | −0.33 | 13.95% | 0.67 |
| | SBS (411) | | | | | | | |

| | | | | | | | |
|---|---|---|---|---|---|---|---|
| 4** | No Radial SBS (411) | 65.6 | −27.12 | −26.12 | −1.00 | 1.64% | 1.41 |
| | or PAEHOSO polymers, | | | | | | |
| | just EMS and 600T | | | | | | |

**Does not contain sulfur**

Tables 11-12 list the MSCR/Jnr results of various different formulations and the reproducibility amongst the samples.

TABLE 11

| Polymer | PAEHOSO | |
|---|---|---|
| M.W. Polymer | 500 | kDa |
| Sulfur dosage | 0.50% | by weight of |
| | | binder |
| EMS | 6.00% | by weight of |
| | | binder |
| Hydroline 600T | 5.00% | by weight of |
| | | binder |
| Binder | VTB | |
| High Temp. PG | 79.9 | ° C. |
| Low Temp. PG | −14.5 | ° C. |
| (m-value) | | |
| Low Temp. PG | −17.35 | ° C. |
| (Stiffness) | | |
| ΔT_{c} | −2.83 | ° C. |

TABLE 12

| | Styrene - | | PAEHOSO | | | | | | |
|---|---|---|---|---|---|---|---|---|---|
| | Butadiene % | | % by wt. | | | Low | | | |
| Blend | by wt. of | | of the | High | Low temp | temp | | MSCR | |
| # | the binder | Functionality | binder | Temp | (Stiffness) | (m-value) | ΔT_{c} | 58° C. | Jnr |
| 1 | 2.0% Radial | 2.2 | 6.00% | 77.4 | −24.14 | −24.66 | 0.52 | 38.99% | 0.259 |
| | SBS (411) | | | | | | | | |
| 2 | 2.0% Radial | 2.2 | 6.00% | 75.4 | −26.16 | −27.06 | 0.9 | 37.79% | 0.317 |
| | SBS (411) | | | | | | | | |
| 3 | 1.0% Radial | 2.2 | 6.00% | 74.3 | −26.8 | −26.8 | 0.0 | 30.18% | 0.305 |
| | SBS (411) | | | | | | | | |
| 4 | 1.0% Radial | 2.2 | 6.00% | 74 | −27.03 | −24.82 | −2.21 | 26.27% | 0.423 |
| | SBS (411) | | | | | | | | |
| 5 | 1.0% Radial | 2.2 | 6.00% | 74.5 | −23.62 | −24.05 | 0.43 | 25.79% | 0.374 |
| | SBS (411) | | | | | | | | |
| 6 | 1.5% Radial | 2.2 | 6.00% | 76.6 | −24.99 | −22.87 | −2.12 | 25.58% | 0.329 |
| | SBS (411) | | | | | | | | |
| 7 | 2.0% Linear | 2.2 | 6.00% | 79.7 | −27.12 | −16.6 | −10.52 | 54.69% | 0.177 |
| | SB (1118) | | | | | | | | |
| 8 | 1.0% Linear | 2.2 | 6.00% | 74.6 | −24.16 | −23.52 | −0.64 | 21.16% | 1.183 |
| | SB (243) | | | | | | | | |
| 9** | 1.0% Radial | — | — | 66.9 | −25.76 | −25.44 | −0.32 | 2.68% | 1.144 |
| | SBS (411) | | | | | | | | |

| | | | | | | | |
|---|---|---|---|---|---|---|---|
| 10** | No Radial SBS (411) or PAEHOSO | 65.6 | −27.12 | −26.12 | −1.00 | 1.64% | 1.41 |
| | polymers, just EMS and 600T | | | | | | |

**Does not contain sulfur**

Tables 13-14 show data with a VTB binder from Heritage. Heritage binder is additional binder that was used for method 2. The results show the performance value by using PAEHOSO with SESO. Additionally, a variety of SBS and SB polymers are shown to display their interaction with PAESOSO/SESO.

TABLE 13

| | 2.2 | |
|---|---|---|
| Polymer | PAEHOSO | |
| M.W. Polymer | 500 | kDa |
| Sulfur dosage | 0.20% | by weight |
| | | of binder |
| Binder | VTB | Heritage |
| | | Group |
| High Temp. PG | 89.1 | ° C. |
| Low Temp. PG | −7.14 | ° C. |
| (m-value) | | |
| Low Temp. PG | −9.26 | ° C. |
| (Stiffness) | | |
| ΔT_{c} | −2.12 | ° C. |
| MSCR 58° C. | 35.29 | % |
| Jnr | 0.021 | |

TABLE 14

| | Styrene- | | | | | | | | |
|---|---|---|---|---|---|---|---|---|---|
| | Butadiene % | | | High | | Low | | | |
| Blend | by wt. of | PAEHOSO | SESO | Temp. | Low temp | temp | | MSCR | |
| # | the binder | % | % | (° C.) | (Stiffness) | (m-value) | ΔT_{c} | 58° C. | Jnr |
| 1 | 2.0% Radial | — | — | 95.9 | −9.73 | −5.13 | −4.6 | 64.63% | 0.0084 |
| | SBS (411) | | | | | | | | |
| 2 | 2.0% Radial | — | 6.0 | 84.8 | −18.08 | −16.94 | −1.14 | 57.28% | 0.044 |
| | SBS (411) | | | | | | | | |
| 3 | 2.0% Radial | — | 12.0 | 73.8 | −31.59 | −26.54 | −5.05 | 36.45% | 0.298 |
| | SBS (411) | | | | | | | | |
| 4 | 2.0% Radial | — | 13.0 | 71.8 | −29.3 | −29.3 | 0 | 25.54% | 0.582 |
| | SBS (411) | | | | | | | | |
| 5 | 2.0% Radial | 6.0 | 12.0 | 74.4 | −27.84 | −31.74 | 3.9 | 34.51% | 0.288 |
| | SBS (411) | | | | | | | | |
| 6 | 2.0% Radial | 6.0 | 13.0 | 71.8 | −28.38 | −29.22 | 0.84 | 26.56% | 0.455 |
| | SBS (411) | | | | | | | | |
| 7 | 2.0% Radial | 6.0 | 13.0 | 71.8 | −30.08 | −30.22 | 0.14 | 28.3% | 0.385 |
| | SBS (411) | | | | | | | | |
| 8 | 2.0% Linear | 6.0 | 13.0 | 71.3 | −30.03 | −31.04 | 1.01 | 29.63% | 0.464 |
| | SB (1118) | | | | | | | | |
| 9 | 2.0% Linear | 6.0 | 13.0 | 72.3 | −30.35 | −30.12 | −0.23 | 36.76% | 0.415 |
| | SB (243) | | | | | | | | |

Tables 15-16 show data with VTB binder. This is using the vacuum tower bottoms from Seneca that used method 2 for blending, except blend 8 used method 1. The results show the performance value by using PAEHOSO with SESO and EMS at two different dosages. Additionally, a variety of SBS and SB polymers are shown to display their interaction with PAESOSO/SESO. The SESO shown is using two various oxirane content. This content is mass % of the molecule and those values are 1.5 and 2.5%. It is unknown whether 1192 is a SB, SBS, linear or radial block copolymer.

TABLE 15

| Polymer | 2.2 PAEHOSO | |
|---|---|---|
| M.W. Polymer | 500 | kDa |
| Sulfur dosage | 0.20% | by weight |
| | | of binder |
| PAEHOSO dosage | 6.0% | By weight |
| | | of binder |
| Binder | VTB | |
| High Temp. PG | 79.9 | ° C. |
| Low Temp. PG | −14.5 | ° C. |
| (m-value) | | |
| Low Temp. PG | −17.35 | ° C. |
| (Stiffness) | | |
| ΔT_{c} | −2.83 | ° C. |
| MSCR 58° C. | 35.29 | % |
| Jnr | 0.021 | |

TABLE 16

| | Styrene- | | | | | | | | | |
|---|---|---|---|---|---|---|---|---|---|---|
| | Butadiene % | | | | High | | | | | |
| Blend | by wt. of | SESO | Hydrolene | EMS | Temp. | Low temp | Low temp | | MSCR | |
| # | the binder | % | 600T % | % | (° C.) | (Stiffness) | (m-value) | ΔT_{c} | 58° C. | Jnr |
| 1* | 2.0% Radial | 11.0 | — | — | 71.4 | −29.07 | −28.14 | −0.93 | 48.24% | 0.421 |
| | SBS (411) | | | | | | | | | |
| 2** | 2.0% Radial | 11.0 | — | — | 68.8 | −41.26 | −34.39 | −6.87 | 43.94% | 0.601 |
| | SBS (411) | | | | | | | | | |
| 3 | 2.0% Radial | — | — | 11.0 | 65.9 | −42.81 | −32.57 | −10.24 | 29.88% | 1.078 |
| | SBS (411) | | | | | | | | | |
| 4 | 2.0% Radial | — | 5.0 | 6.0 | 73.2 | −26.78 | −28.33 | 1.55 | 48.36% | 0.338 |
| | SBS (411) | | | | | | | | | |
| 5 | 2.0% Linear | — | 5.0 | 6.0 | 70.7 | −26.55 | −23.73 | −2.82 | 24.24% | 0.579 |
| | SB (243) | | | | | | | | | |
| 6*** | 2.0% Linear | — | 5.0 | 6.0 | 74.1 | −25.29 | −24.72 | −0.57 | 41.24% | 0.324 |
| | SB (243) | | | | | | | | | |
| 7*** | 2.0% (1192) | — | 5.0 | 6.0 | 76.2 | −24.79 | −22.74 | −2.05 | 48.56% | 0.274 |
| 8**** | 2.0% Linear | 6.0 | 5.0 | — | 73.8 | −28.1 | −26.87 | −1.23 | 34.1% | 0.365 |
| | SB (1118) | | | | | | | | | |

*The rejuvenator is SESO with 1.5% oxirane
**The rejuvenator is SESO with 2.5% oxirane
***0.5% by weight of binder sulfur dosage was added
****Followed method [1]

Tables 17-18 show data with 64-22 Binder. This is using various 64-22 that used method 2 for blending. The SESO shown is using two various oxirane content. This content is mass % of the molecule and those values are 1.5 and 2.5%.

TABLE 17

| | 2.2 | | | |
|---|---|---|---|---|
| Polymer | PAEHOSO | | | |
| M.W. Polymer | 500 | kDa | | |
| Sulfur dosage | 0.20% | by weight | | |
| | | of binder | | |
| Binder | Seneca 64-22 | Jebro | Bituminous | |
| | | | Materials | |
| High Temp. PG | 65.6 | 65.6 | 66.2 | ° C. |
| Low Temp. PG | −23.9 | −24.89 | −25.47 | ° C. |
| (m-value) | | | | |
| Low Temp. PG | −26.04 | −24.69 | −24.33 | ° C. |
| (Stiffness) | | | | |
| ΔT_{c} | −2.11 | 0.2 | 1.14 | ° C. |
| MSCR | 2.30% | 3.6% | 1.21% | |
| Jnr | | | 1.45 | @58° C. |

TABLE 18

| | Styrene- | | | | | | | | | |
|---|---|---|---|---|---|---|---|---|---|---|
| | Butadiene % | | | | High | | Low | | | |
| Blend | by wt. of | SESO | | EMS | Temp. | Low temp | temp | | MSCR | |
| # | the binder | % | Binder | % | (° C.) | (Stiffness) | (m-value) | ΔT_{c} | 58° C. | Jnr |
| 1* | 2.0% Radial | 6.0 | Seneca | — | 64.4 | −35.76 | −30.6 | −5.16 | 50.47% | 0.754 |
| | SBS (411) | | | | | | | | | |
| 2** | 2.0% Radial | 6.0 | Seneca | — | 66.0 | −38.96 | −31.22 | −7.74 | 50.00% | 0.638 |
| | SBS (411) | | | | | | | | | |
| 3* | 2.0% Radial | 6.0 | Seneca | — | 63.8 | −35.37 | −33.86 | −1.51 | 49.69% | 0.825 |
| | SBS (411) | | | | | | | | | |
| 4 | 2.0% Radial | — | Jebro | 6.0 | 63.6 | −30.8 | −31.91 | 1.11 | 29.09% | 1.353 |
| | SBS (411) | | | | | | | | | |
| 5 | 2.0% Radial | — | Bituminous | 6.0 | 62.5 | −36.06 | −35.75 | −0.31 | 44.38% | 0.625 |
| | SBS (411) | | Materials | | | | | | | |
| 7 | 2.0% Radial | — | Bituminous | 6.0 | 64.2 | −36.19 | −38.47 | 2.28 | 39.9% | 0.511 |
| | SBS (411) | | Materials | | | | | | | |

*The rejuvenator is SESO with 1.5% oxirane
**The rejuvenator is SESO with 2.5% oxirane

Although preferred embodiments have been depicted and described in detail herein, it will be apparent to those skilled in the relevant art that various modifications, additions, substitutions, and the like can be made without departing from the spirit of the application and these are therefore considered to be within the scope of the application as defined in the claims which follow.

What is claimed:

1. A composition comprising:
a polymer comprising two or more units of monomer A, with monomer A being a radically polymerizable plant oil, animal oil, synthetic triglyceride, or mixture thereof and
an epoxidized vegetable oil, an epoxidized fatty acid, or an epoxidized fatty ester.

2. The composition of claim 1, wherein monomer A is a radically polymerizable plant oil monomer selected from the group consisting of soybean oil, corn oil, linseed oil, flax seed oil, and rapeseed oil.

3. The composition of claim 2, wherein monomer A is a high oleic soybean oil.

4. The composition of claim 1, wherein the polymer comprises a polymerized triglyceride.

5. The composition of claim 4, wherein the polymerized triglyceride comprises one or more conjugated sites.

6. The composition of claim 5, wherein the one or more conjugated sites are formed by acrylate groups.

7. The composition of claim 4, wherein the triglyceride is an acrylated epoxidized triglyceride.

8. The composition of claim 1, wherein monomer A is an acrylated epoxidized high oleic soybean oil.

9. The composition of claim 1, wherein the epoxidized vegetable oil, the epoxidized fatty acid, or the epoxidized fatty ester is selected from the group consisting of sub-epoxidized vegetable oil, sub-epoxidized fatty acid, and sub-epoxidized fatty ester.

10. The composition of claim 1, wherein the epoxidized vegetable oil, the epoxidized fatty acid, or the epoxidized fatty ester is selected from the group consisting of fully epoxidized fatty acid and fully epoxidized fatty ester.

11. The composition of claim 1, wherein the epoxidized vegetable oil, the epoxidized fatty acid, or the epoxidized fatty ester is in a mixture of a vegetable oil, a fatty acid, and/or a fatty ester.

12. The composition of claim 1, wherein the epoxidized vegetable oil, the epoxidized fatty acid, or the epoxidized fatty ester is a compound of Formula (I): 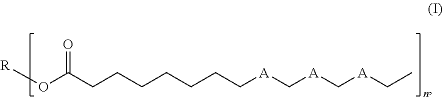
wherein:
each A is independently selected at each occurrence thereof from the group consisting of a bond, 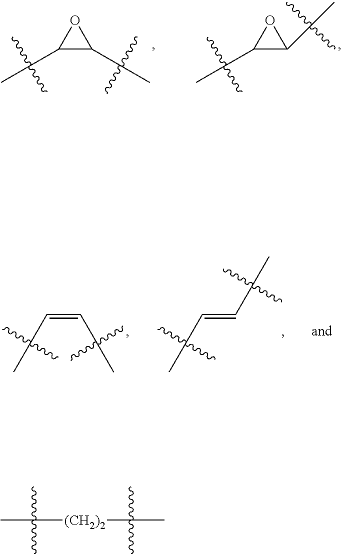
and
wherein at least one A is 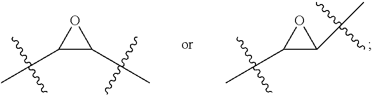 [SMILES: *C1OC1* ; *C1OC1*]
each 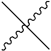
represents the point of attachment to a —CH₂— group;
n is 1, 2, or 3;
R is independently selected at each occurrence thereof from the group consisting of H, C₁-C₂₃ alkyl, and arylalkyl, wherein the C₁-C₂₃ alkyl can be optionally substituted with an aryl, heteroaryl, or heterocyclyl; or
R is independently selected at each occurrence thereof from the group consisting of 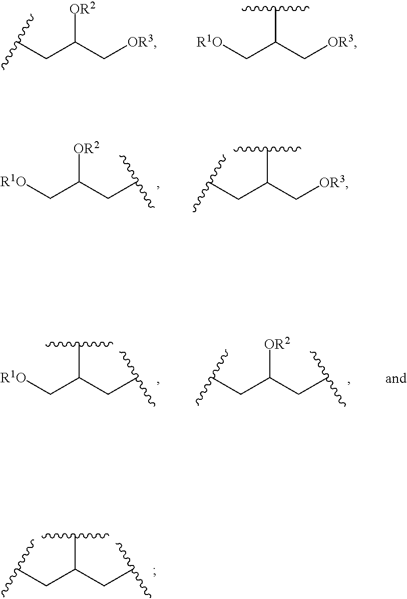
each 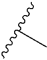
represents the point of attachment to a 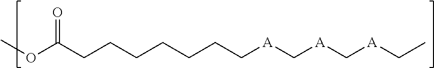
moiety;
R¹, R², and R³ are independently selected at each occurrence thereof from the group consisting of —H and —C(O)R⁴; and
R⁴ is independently selected at each occurrence thereof H, C₁-C₂₃ alkyl, or aryl.

13. The composition of claim 12, wherein the compound of Formula (I) is the compound of any one of Formulae (Ia)-(Ik) or any combination thereof:

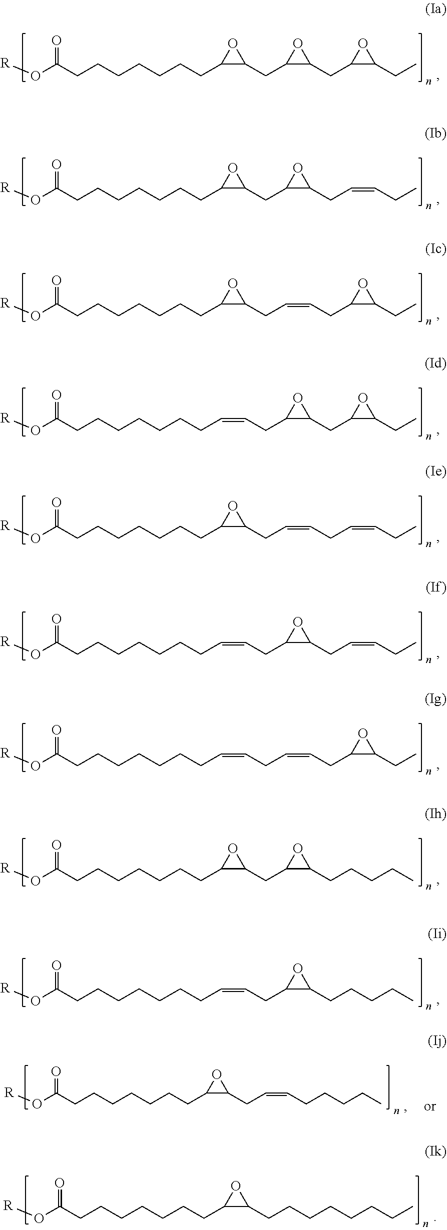

14. The composition of claim 11, wherein the mixture further comprises one or more of compounds of Formulae (IIa)-(IIc):

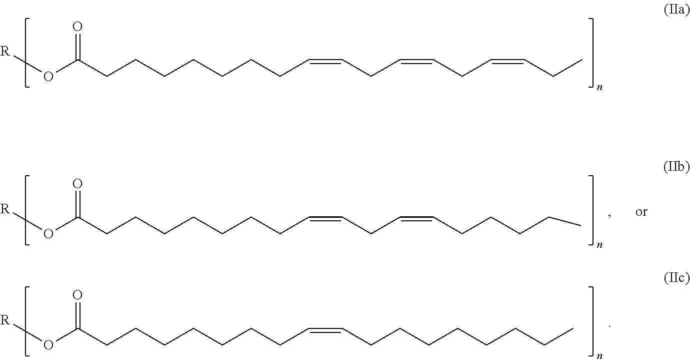

15. The composition of claim 12, wherein the compound of Formula (I) is selected from the group consisting of epoxidized methyl soyate (“EMS”), epoxidized benzyl soyate (“EBS”), sub-epoxidized soybean oil (“SESO”), epoxidized soybean oil (“ESO”), epoxidized isoamyl soyate, sub-epoxidized corn oil, epoxidized corn oil, sub-epoxidized rapeseed oil, epoxidized rapeseed oil, sub-epoxidized linseed oil, and epoxidized oil.

16. The composition of claim 15, wherein the compound of Formula (I) is a sub-epoxidized soybean oil containing 0.1-6.5 wt % of oxirane.

17. The composition of claim 16, wherein the compound of Formula (I) is a sub-epoxidized soybean oil containing 2.5-4.5 wt % of oxirane.

18. The composition of claim 12, wherein the compound of Formula (I) is selected from the group consisting of:

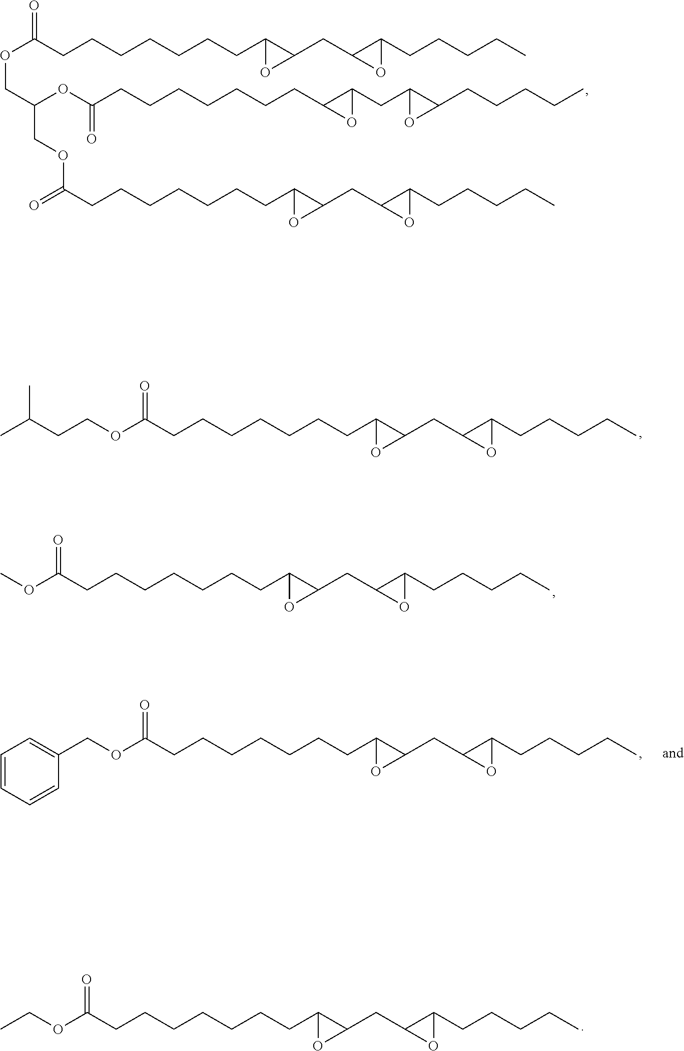

19. The composition of claim 1, wherein the polymer is present in the composition in an amount of from 10 to 90 wt %.

20. The composition of claim 19, wherein the polymer is present in the composition in an amount of from 30 to 70 wt %.

21. The composition of claim 1, wherein the epoxidized vegetable oil, epoxidized fatty acid, or epoxidized fatty ester is present in the composition in an amount of from 25 to 75 wt %.

22. The composition of claim 21, wherein the epoxidized vegetable oil, epoxidized fatty acid, or epoxidized fatty ester is present in the composition in an amount of from 30 to 55 wt %.

23. The composition of claim 1 further comprising:
an asphalt polymer modifier.

24. The composition of claim 23, wherein the asphalt polymer modifier is selected from the group consisting of polyphosphoric acid (“PPA”), styrene/butadiene block copolymers (“SBS”), styrene/butadiene rubbers (“SBR”), styrene/isoprene block copolymers (“SIS”), ethylene/acrylate copolymers, ethylene/vinyl acetate copolymers (“EVA”), and mixtures thereof.

25. The composition of claim 23, wherein the asphalt polymer modifier is present in the composition in an amount of from 0.1 to 25 wt %.

26. The composition of claim 25, wherein the asphalt polymer modifier is present in the composition in an amount of from 10 to 18 wt %.

27. The composition of claim 1 further comprising:
an asphalt portion.

27. The method of claim 46, wherein the epoxidized vegetable oil, the epoxidized fatty acid, or the epoxidized fatty ester is present in the liquid cement composition in an amount of from 25 to 75 wt %.

28. The composition of claim 27, wherein the asphalt portion is selected from the group consisting of polymer modified asphalt cement (“PMAC”), vacuum tower bottoms (“VTB”), oxidized asphalts, reclaimed asphalt pavement (“RAP”), and a virgin binder.

29. The composition of claim 27 further comprising:
a cross-linker.

30. The composition of claim 29, wherein the cross-linker is selected from the group consisting of a thiol-based compound and an acid-based compound.

31. The composition of claim 29, wherein the cross-linker is present in the composition in an amount between 0.1 to 0.5 wt %.

32. The composition of claim 1, wherein the composition has a viscosity ranging from 500 cP to 55000 cP at 50° C.

33. The composition of claim 1, wherein the composition exhibits an improved MSCR elastic recovery ranging from 4% to 97% measured at 58° C. compared to an asphalt portion alone.

34. A composition comprising:
a polymer comprising two or more units of monomer A, with monomer A being a radically polymerizable plant oil, animal oil, synthetic triglyceride, or mixture thereof;
an epoxidized vegetable oil, an epoxidized fatty acid, or an epoxidized fatty ester;
an asphalt polymer modifier;
a cross-linker; and
an asphalt portion.

35. The composition of claim 34 further comprising:
a hot-mix asphalt rejuvenator and/or a softening agent.

36. The composition of claim 34, wherein the composition exhibits an improved low temperature PG grade ranging from 1° C. to 24° C. lower than an asphalt portion alone.

37. The composition of claim 34, wherein the composition exhibits an improved high temperature PG ranging from 0° C. to 24° C. higher than an asphalt portion alone.

38. A method of producing a liquid cement composition comprising:
providing a polymer comprising two or more units of monomer A, with monomer A being a radically polymerizable plant oil, animal oil, synthetic triglyceride, or mixture thereof;
providing an epoxidized vegetable oil, an epoxidized fatty acid, or an epoxidized fatty ester; and
mixing the polymer with the epoxidized vegetable oil, the epoxidized fatty acid, or the epoxidized fatty ester to produce a liquid cement composition.

39. The method of claim 38, wherein monomer A is a radically polymerizable plant oil monomer selected from the group consisting of soybean oil, corn oil, linseed oil, flax seed oil, and rapeseed oil.

40. The method of claim 38, wherein the polymer comprises a polymerized triglyceride.

41. The method of claim 40, wherein the polymerized triglyceride comprises one or more conjugated sites.

42. The method of claim 38, wherein the epoxidized vegetable oil, the epoxidized fatty acid, or the epoxidized fatty ester is selected from the group consisting of sub-epoxidized vegetable oil, sub-epoxidized fatty acid, and sub-epoxidized fatty ester.

43. The method of claim 38, wherein the epoxidized vegetable oil, the epoxidized fatty acid, or the epoxidized fatty ester is selected from the group consisting of fully epoxidized fatty acid and fully epoxidized fatty ester.

44. The method of claim 38, wherein the epoxidized vegetable oil, the epoxidized fatty acid, or the epoxidized fatty ester is in a mixture of a vegetable oil, a fatty acid, and/or a fatty ester.

45. The method of claim 38, wherein the epoxidized vegetable oil, the epoxidized fatty acid, or the epoxidized fatty ester is a compound of Formula (I): 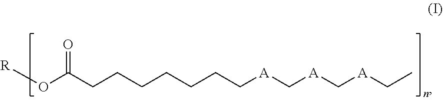
wherein:
each A is independently selected at each occurrence thereof from the group consisting of a bond, 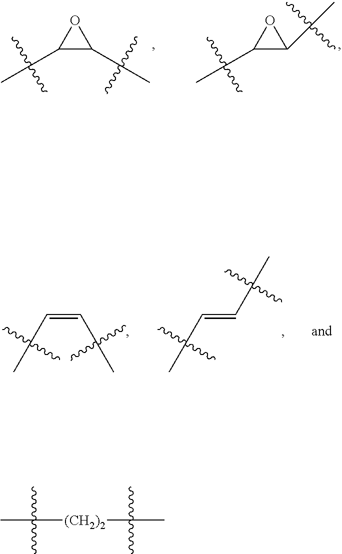
and
wherein at least one A is 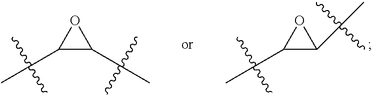 [SMILES: *C1OC1* ; *C1OC1*]
each 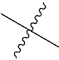
represents the point of attachment to a —CH₂— group;
n is 1, 2, or 3;
R is independently selected at each occurrence thereof from the group consisting of H, C₁-C₂₃ alkyl, and arylalkyl, wherein the C₁-C₂₃ alkyl can be optionally substituted with an aryl, heteroaryl, or heterocyclyl; or
R is independently selected at each occurrence thereof from the group consisting of 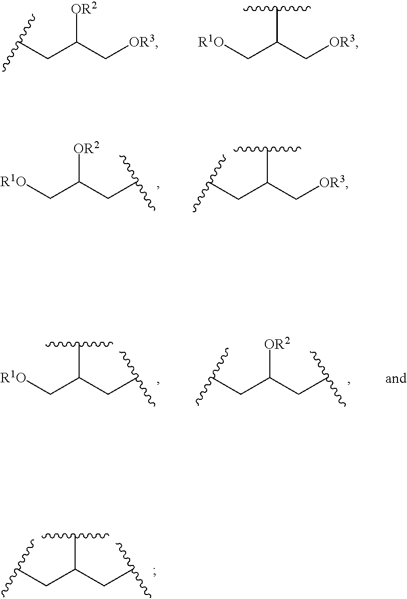
each represents the point of attachment to a 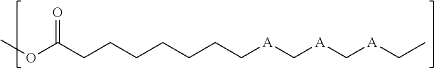
moiety;
R¹, R², and R³ are independently selected at each occurrence thereof from the group consisting of —H and —C(O)R⁴; and
R⁴ is independently selected at each occurrence thereof H, C₁-C₂₃ alkyl, or aryl.

46. The method of claim 38, wherein the polymer is present in the liquid cement composition in an amount of from 10 to 90 wt %.

48. The method of claim 38 further comprising:
providing an asphalt polymer modifier and
mixing the asphalt polymer modifier with the liquid cement to produce an improved liquid cement composition.

49. The method of claim 48, wherein the asphalt polymer modifier is selected from the group consisting of polyphosphoric acid (“PPA”), styrene/butadiene block copolymers (“SBS”), styrene/butadiene rubbers (“SBR”), styrene/isoprene block copolymers (“SIS”), ethylene/acrylate copolymers, ethylene/vinyl acetate copolymers (“EVA”), and mixtures thereof.

50. The method of claim 48, wherein the asphalt polymer modifier is present in the liquid cement composition in an amount of from 0.1 to 25 wt %.

51. The method of claim 38 further comprising:
providing an asphalt portion and
mixing the liquid cement composition with the asphalt portion to produce a liquid asphalt cement composition.

52. The method of claim 51, wherein the asphalt portion is selected from the group consisting of polymer modified asphalt cement (“PMAC”), vacuum tower bottoms (“VTB”), oxidized asphalts, reclaimed asphalt pavement (“RAP”), and a virgin binder.

53. The method of claim 51 further comprising:
providing a cross-linker and
mixing the liquid asphalt cement composition with the cross-linker to form a liquid asphalt cement blend composition.

54. The method of claim 53, wherein the cross-linker is selected from the group consisting of a thiol-based compound and an acid-based compound.

55. The method of claim 54, wherein the cross-linker is present in the liquid asphalt cement blend composition in an amount between 0.1 to 0.5 wt %.

56. The method of claim 51 further comprising:
providing a hot-mix asphalt rejuvenator and/or a softening agent and
mixing the hot-mix asphalt rejuvenator and/or softening agent with the liquid asphalt cement composition to produce a rejuvenated liquid cement composition.

57. A method of paving comprising:
(a) providing the composition of claim 1;
(b) mixing the composition with a mineral aggregate to form a mixture;
(c) applying the mixture to a surface to be paved to form an applied paving material, and
(d) compacting the applied paving material to form a paved surface.

58. The method of claim 57 further comprising:
providing an asphalt polymer modifier and
mixing the asphalt polymer modifier with the mixture prior to said applying the mixture and prior to said compacting the applied paving material.

59. The method of claim 57 further comprising:
providing an asphalt portion and
mixing the asphalt portion with the mixture prior to said applying the mixture and prior to said compacting the applied paving material.

60. The method of claim 59 further comprising:
providing a cross-linker and
mixing the cross-linker with the mixture and the asphalt polymer modifier prior to said applying the mixture and prior to said compacting the applied paving material.

61. The method of claim 57, wherein the mineral aggregate is selected from the group consisting of sand, gravel, limestone, crushed stone, and combinations thereof.

62. The method of claim 59 further comprising:
providing a hot-mix asphalt rejuvenator and/or a softening agent and
mixing the hot-mix asphalt rejuvenator and/or softening agent with the mixture of the cross-linker and the asphalt polymer modifier.
